(19) United States
(12) Patent Application Publication
(10) Pub. No.: US 2025/0349067 A1
(43) Pub. Date: Nov. 13, 2025

(54) Picture Rendering Methods and Systems

(71) Applicant: Tencent Technology (Shenzhen) Company Limited, Shenzhen (CN)

(72) Inventor: Jie Li, Shenzhen (CN)

(21) Appl. No.: 19/274,927

(22) Filed: Jul. 21, 2025

Related U.S. Application Data
(63) Continuation of application No. PCT/CN2024/096966, filed on Jun. 3, 2024.

(30) Foreign Application Priority Data
Aug. 18, 2023 (CN) 2023110473513

(51) Int. Cl. G06T 15/50; G06T 15/04

(52) U.S. Cl. CPC G06T 15/506; G06T 15/04; G06T 2210/12

(57) ABSTRACT

Picture rendering techniques for virtual environments are described herein. The techniques may include: obtaining geometric information of at least one reflection capture object in a virtual scene; determining, in the presence of a target reflection capture object having a reflection effect changed, a target virtual object from virtual objects included in a field of view according to the geometric information of the target reflection capture object, where the target virtual object is a virtual object having a surface display effect changed when the reflection effect of the target reflection capture object is changed; re-rendering the target virtual object to generate a re-rendered target virtual object, where a texture of a material surface of the re-rendered target virtual object is changed; and generating a display picture of the field of view according to the re-rendered target virtual object and virtual objects other than the target virtual object. The described techniques improve rendering performance.

### CROSS-REFERENCE TO RELATED APPLICATIONS

This application is a Continuation of PCT Application No. PCT/CN2024/096966, filed Jun. 3, 2024, and claims priority to Chinese Patent Application No. 202311047351.3, filed Aug. 18, 2023, each entitled “Picture Rendering Method and Apparatus, Device, and Storage Medium” each of which is incorporated by reference in its entirety.

### FIELD

Aspects described herein relate to the field of computer and Internet technologies, and in particular, to a picture rendering method and apparatus, a device, and a storage medium, for rendering images in a virtual scene or environment.

### BACKGROUND

After a reflection capture object is provided in a virtual scene, a reflection effect is displayed on a surface since a virtual object in the virtual scene is affected by the reflection capture object, so that a material of the virtual object is more vivid. The reflection capture object is an object determined based on a reflection capture (RC) technology.

In the related art, after a reflection state of the reflection capture object is changed, a terminal device needs to update a rendering instruction (Drawcall) corresponding to each virtual object according to attribute information of the virtual object in the virtual scene, so as to control a graphics processing unit to render each virtual object according to the updated rendering instruction in a process of generating a next display picture, to generate a next display picture.

However, this manner needs to consume a large quantity of computing resources, and rendering performance of the terminal device needs to be further improved.

### SUMMARY

Aspects described herein provide a picture rendering method and apparatus, a device, and a storage medium. The following technical solutions are adopted.

According to an aspect of an aspect described herein, a picture rendering method is provided. The method is performed by a terminal device. The method includes:
obtaining reflection capture information of a virtual scene, where the reflection capture information includes geometric information of at least one reflection capture object, and the reflection capture object is configured for projecting a cube map representing a reflection effect onto a material surface of a virtual object;
determining, in the presence of a target reflection capture object having the reflection effect changed in the at least one reflection capture object, at least one target virtual object from at least one virtual object included in a field of view according to the geometric information of the target reflection capture object, where the target virtual object is a virtual object having a surface display effect changed when the reflection effect of the target reflection capture object is changed;
re-rendering the target virtual object to generate a re-rendered target virtual object, where a texture of the material surface of the re-rendered target virtual object is changed; and
generating a display picture of the field of view according to the re-rendered target virtual object and virtual objects other than the target virtual object in the at least one virtual object.

According to an aspect of an aspect described herein, a picture rendering apparatus is provided. The apparatus includes:
an information obtaining module, configured to obtain reflection capture information of a virtual scene, where the reflection capture information includes geometric information of at least one reflection capture object, and the reflection capture object is configured for projecting a cube map representing a reflection effect onto a material surface of a virtual object;
an object determining module, configured to determine, in the presence of a target reflection capture object having the reflection effect changed in the at least one reflection capture object, at least one target virtual object from at least one virtual object included in a field of view according to the geometric information of the target reflection capture object, where the target virtual object is a virtual object having a surface display effect changed when the reflection effect of the target reflection capture object is changed;
an object rendering module, configured to re-render the target virtual object to generate a re-rendered target virtual object, where a texture of the material surface of the re-rendered target virtual object is changed; and
a picture generation module, configured to generate a display picture of the field of view according to the re-rendered target virtual object and virtual objects other than the target virtual object in the at least one virtual object.

According to an aspect of an aspect described herein, a terminal device is provided. The terminal device includes a processor and a memory. The memory has a computer program stored therein. The computer program is loaded and executed by the processor to implement the foregoing picture rendering method.

According to an aspect of an aspect described herein, a computer-readable storage medium is provided. The storage medium has a computer program stored therein. The computer program is loaded and executed by a processor to implement the foregoing picture rendering method.

According to an aspect of an aspect described herein, a computer program product is provided. The computer program product includes a computer program. The computer program is stored in a computer-readable storage medium. A processor reads and executes the computer program from the computer-readable storage medium, to implement the foregoing picture rendering method.

The technical solutions provided in the aspects described herein produce at least the following beneficial effects.

In a case that a reflection effect of a reflection capture object is changed, a virtual object affected by the reflection capture object is selected from virtual objects included in a field of view, and only a rendering instruction of the selected virtual object is updated, so that the number of updated rendering instructions can be effectively reduced. In this manner, the problem of a computing pressure rise caused by updating the rendering instruction when the reflection effect of the reflection capture object is changed is reduced, thereby reducing power consumption of a terminal device.

In addition, by reducing the number of virtual objects needing to be updated and rendered, a computing pressure in a process of generating a display picture by the terminal device when the reflection effect of the reflection capture object is changed is reduced, thereby reducing a probability that a picture frame freezing problem occurs. Therefore, a frame rate at which the display picture is updated keeps stable, thereby improving rendering performance of the terminal device, and maintaining smoothness of the display picture in a use process of a target application.

### BRIEF DESCRIPTION OF THE DRAWINGS

FIG. 1 is a schematic diagram of a solution implementation environment according to an illustrative aspect described herein.

FIG. 2 is a schematic diagram of a transformation process from a three-dimensional space to a two-dimensional image according to an illustrative aspect described herein.

FIG. 3 is a schematic diagram of a picture rendering method in the related art.

FIG. 4 is a schematic diagram of a computing overhead change according to an illustrative aspect described herein.

FIG. 5 is a schematic diagram of a picture rendering method according to an illustrative aspect described herein.

FIG. 6 is a flowchart of a picture rendering method according to an illustrative aspect described herein.

FIG. 7 is a schematic diagram of a reflection effect according to an illustrative aspect described herein.

FIG. 8 is a schematic diagram of a reflection capture information format according to an illustrative aspect described herein.

FIG. 9 is a schematic diagram of a picture rendering method according to an illustrative aspect described herein.

FIG. 10 is a block diagram of a picture rendering apparatus according to an illustrative aspect described herein.

FIG. 11 is a structural block diagram of a terminal device according to an illustrative aspect described herein.

### DETAILED DESCRIPTION

To make the objectives, technical solutions, and advantages described herein clearer, the following further describes implementations described herein in detail with reference to the accompanying drawings.

Before describing the various aspects, a general introduction is provided.

A reflection capture (RC) technology is a technology for capturing ambient reflection and diffuse reflection in a rendering process. The reflection capture technology may simulate reflection and indirect illumination of a material and a scene, and greatly helps improve sense of reality and details of the scene.

A rendering instruction (Drawcall) is configured for: triggering to complete a data transmission and command calling process between a central processing unit (CPU) and a graphics processing unit (GPU). In computer graphics, in a process of submitting the rendering instruction to the graphics processing unit, rendering information generated each time is implemented by using the rendering instruction. The rendering instruction includes all operations required for rendering a virtual object, such as model conversion, texture sampling, and shader calculation. Optimization of the number of rendering instructions is an important factor for improving performance of an application.

A bounding box (BB) is: a rectangular boundary box representing a position and a size of the virtual object in the virtual scene. The bounding box is usually determined by four values, which are respectively x and y coordinate information at an upper left corner and a width and height of a rectangle.

An axis aligned bounding box (AABB) is: a frame or a bounding box formed by two rectangles that are perpendicular and parallel, where coordinates of a diagonal vertex of the first rectangle are (A, A), and coordinates of a diagonal vertex of the second rectangle are (B, B).

A virtual scene is: a three-dimensional space designed to implement functions of a target application. A virtual object in the virtual scene belongs to a three-dimensional model. A world coordinate system is provided in the virtual scene. A position of the virtual object in the virtual scene may be determined by using the world coordinate system. A game application is used as an example. A virtual environment is a scene displayed (or provided) when a client of the game application runs on a terminal device. The virtual environment is an environment created for a virtual character to perform activities (such as game competition), for example, a virtual house, a virtual island, or a virtual map. The virtual environment may be a simulated environment of a real world, or may be a semi-simulated and semi-fictional environment, or may be an entirely fictional environment. The virtual environment may be a 3-dimensional virtual environment or a 2.5-dimensional virtual environment. This is not specifically limited in an aspect described herein. The virtual object may be any object in a virtual scene, for example, a virtual building, a virtual road, a virtual character, or a virtual animal. This is not limited in this aspect described herein.

A virtual camera (VC) is: an object that is provided in the virtual scene and has an observation capability for the virtual object in the virtual scene. The virtual camera can follow the virtual character to move in the virtual scene. In some aspects, a position of the virtual camera in the virtual scene is independent of the virtual character. To be specific, during movement of the virtual character in the virtual scene, the position of the virtual camera does not change with movement of the virtual character. In some aspects, the virtual camera is placed in the virtual scene. For example, the virtual camera is placed on a surface of a virtual object that cannot be reached by the virtual character. For example, the virtual camera is disposed on a virtual building surface in the virtual scene.

Frustum culling is configured for: culling, in computer graphics, a virtual object (including a geometric body or another rendering object) not within a field of view according to a frustum of the virtual camera.

Occlusion query (OC) is configured for: determining which virtual objects in the virtual scene are visible and which virtual objects are occluded.

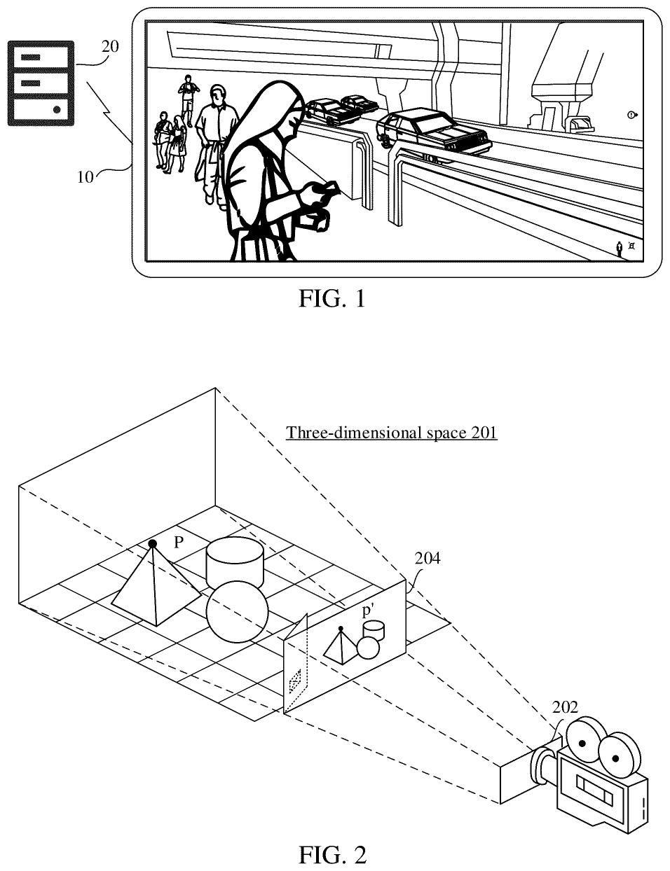

FIG. 1 is a schematic diagram of a solution implementation environment according to an illustrative aspect described herein. The solution implementation environment may be implemented as a computer system such as a game application system. The solution implementation environment may include: a terminal device 10 and a server 20.

The terminal device 10 may be an electronic device such as a mobile phone, a tablet computer, a personal computer (PC), a game console, a multimedia playback device, a wearable device, an intelligent voice interaction device, an intelligent home appliance, an in-vehicle terminal, a virtual reality (VR) device, an augmented reality (AR) device, an extended reality device, or a mixed reality (MR) device. In an example, a target application is run in the terminal device 10. The target application may be a game application, or may be another application that provides a display picture about a virtual scene, such as a virtual reality application, an augmented reality application, a three-dimensional map program, a social application, or an interactive entertainment application. This is not limited in this aspect described herein.

In some aspects, the game application includes at least one of the following: an open world game, a first person shooting (FPS) game, an adventure game (ATG), an action game (ACT), a multiplayer online battle arena (MOBA) game, a simulation game (SLG), and the like. The open world game is an interactive game that may be freely explored, and is alternatively referred to as a free roam game. In the game, a player may freely roam in a virtual world, and may freely select a time point and manner of completing a game task. For the open world game, because the “world” brings a high-complexity virtual scene and because the “open” feature brings a large degree of freedom, the player is more likely to frequently trigger an update of reflection capture during exploration of the game, thereby causing a picture frame freezing problem.

For example, an example in which the target application is a game application is used. A game battle of the target application is completed in a virtual scene, and a virtual object is provided in the virtual scene. The virtual object may be, for example, a game prop or a landscape object (such as a building or a lake) in the virtual scene. The terminal device 10 renders the virtual object in a field of view of a game object (for example, a game character controlled by a user account), to obtain a display picture of the field of view.

To achieve an immersive effect, a surface texture of the virtual object needs to be reflected or rendered otherwise, so that a material of the virtual object is more vivid.

The server 20 can provide a background service for the target application running on the terminal device 10. For example, the server 20 may be a background server of the target application. The server 20 may provide a service for the terminal device. The server 20 may be an independent physical server, a server cluster composed of a plurality of physical servers or a distributed system, and may further be a cloud server that provides basic cloud computing services such as a cloud service, cloud computing, a cloud function, cloud storage, a network service, cloud communication, a domain name service, and an artificial intelligence platform. The server 20 has at least a data receiving and transmitting function, a data storage function, and a data computing function.

In some aspects, the server 20 provides data such as a game installation package and a game patch package for the terminal device 10. The terminal device 10 downloads data related to the target application from the server 20. After installation of the target application is completed, a game battle may be started by running the target application using the terminal device 10. In a process of the game battle, the terminal device 10 renders the virtual object in the virtual scene, and generates and displays a display picture of the field of view.

The following describes an imaging principle of the virtual object in the field of view (i.e. an obtaining principle of the display picture corresponding to the virtual scene in this aspect described herein).

A camera model is a computing model for converting a three-dimensional virtual object into a two-dimensional picture in computer vision. An imaging plane to which the display picture belongs may be a plane perpendicular to a photographing direction of a camera model. For example, when the camera model uses a third-person perspective to photograph in a top view, the imaging plane is a horizontal plane in the virtual scene. When the camera model uses a first-person perspective to photograph in a horizontal view, the imaging plane is parallel to a vertical direction. The horizontal plane is a plane perpendicular to a simulated gravity direction in the virtual scene. The vertical direction is parallel to the simulated gravity direction in the virtual scene. The imaging plane is typically a rectangle, and is alternatively referred to as an imaging rectangle. Virtual photosensitive elements on the imaging plane are in one-to-one correspondence with pixels on a terminal screen.

For example, the world space coordinate system may be obtained by transforming a three-dimensional model in a model space coordinate system through a model transformation matrix. The model space coordinate system is configured for indicating position information of the three-dimensional model. Coordinate information of each three-dimensional model in the model space coordinate system is unified into the world space coordinate system in the three-dimensional space by using the model transformation matrix. For example, the three-dimensional model in the world space coordinate system is transformed into a camera space coordinate system by using a view matrix. The camera space coordinate system is configured for describing coordinates of the three-dimensional model observed by using a camera model. For example, a position of the camera model is used as an origin of coordinates. A three-dimensional model of a camera space coordinate system is transformed into a cropping space coordinate system by using a projection matrix, to obtain a two-dimensional picture. The cropping space coordinate system is configured for describing a projection of the three-dimensional model in a frustum of the camera model. A commonly used perspective projection matrix (a projection matrix) is configured for projecting the three-dimensional model into a model that meets a “near-large, far-small” human eye observation rule. For example, the model transformation matrix, the view matrix, and the projection matrix are generally collectively referred to as model view projection (MVP) matrices.

FIG. 2 is a schematic diagram of a transformation process from a three-dimensional space to a two-dimensional image according to an illustrative aspect described herein.

With reference to FIG. 2, a process of mapping a feature point P in a three-dimensional space 201 to a feature point p′ in an imaging plane 204 (an image coordinate system, or referred to as a pixel coordinate system) is shown. Coordinates of the feature point p in the three-dimensional space 201 are in a three-dimensional form, and coordinates of the feature point p′ in the imaging plane 204 are in a two-dimensional form. The three-dimensional space 201 is a three-dimensional space corresponding to a virtual scene. A camera plane 202 is determined by a pose of a camera model. The camera plane 202 is a plane perpendicular to a photographing direction of the camera mode. The imaging plane 204 and the camera plane 202 are parallel to each other. The imaging plane 204 corresponds to a region located within the field of view when the virtual scene is observed. In some aspects, the virtual camera may be implemented as the camera model.

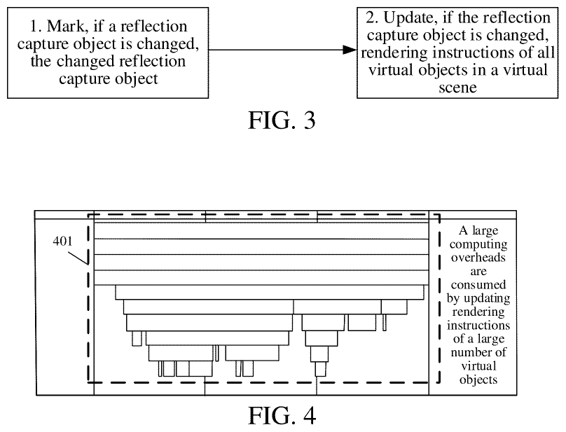

FIG. 3 is a schematic diagram of a picture rendering method in the related art.

In the related art, 1. In a case that a reflection effect of a reflection capture object in a virtual scene is changed, a terminal device marks the reflection capture object having the reflection effect changed. 2. The terminal device generates rendering instructions respectively corresponding to all virtual objects in the virtual scene. In this manner, it is ensured that a map on a material surface of each virtual object can be synchronously changed with the change of the reflection capture object, to improve vividness of a display picture within the generated field of view, and implement correct drawing of the virtual scene.

However, in this method, to ensure correct drawing of the virtual scene, a large number of rendering instructions need to be updated. In a complex scene, if the reflection capture object is changed, a large number of rendering instructions need to be updated, causing frame freezing of the display picture. Especially in the open world game, the “world” brings a more complex virtual scene, and the “open” brings a higher degree of freedom. When a player controls a virtual character to explore in such a complex virtual scene, a reflection effect of a reflection capture object is frequently triggered to be changed, so that computing overheads of the terminal device are greatly increased.

FIG. 4 is a schematic diagram of a computing overhead change according to an illustrative aspect described herein. As shown in FIG. 4, a histogram 401 shows a case that computing overheads of a terminal device are changed with time. After a reflection capture object is changed, because the terminal device needs to update a large number of rendering instructions of a virtual object, the computing overheads are suddenly increased. In this way, a frame rate of a display picture is unstable, or even the display picture is excessively not smooth or frame freezing easily occurs.

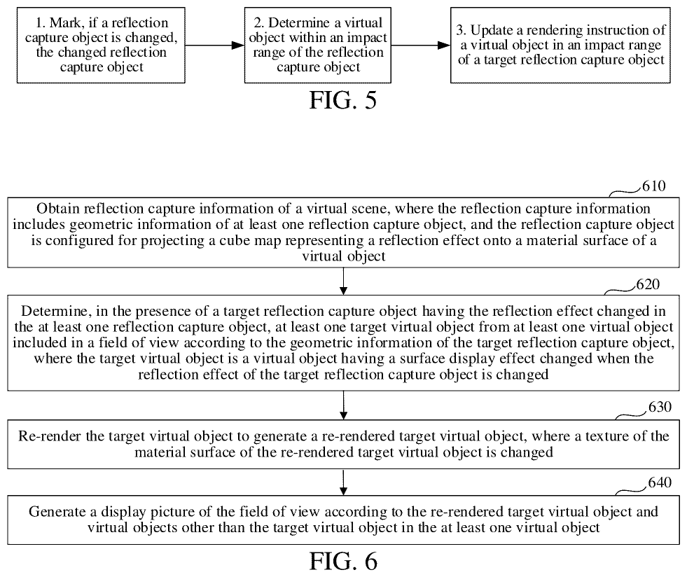

FIG. 5 is a schematic diagram of a picture rendering method according to an illustrative aspect described herein.

1. In a case that a reflection effect of a reflection capture object in a virtual scene is changed, a terminal device marks a target reflection capture object having the reflection effect changed. 2. The terminal device determines a virtual object within an impact range of the reflection capture object. 3. A rendering instruction of the virtual object within an impact range of the target reflection capture object is updated. For example, if a virtual object is not within the impact range of the reflection capture object, a surface texture of the virtual object is not affected by the reflection capture object, and a rendering instruction does not need to be generated again for the virtual object. If a virtual object is within the impact range of the reflection capture object, a surface texture of the virtual object is changed with the change of the reflection capture object, and a rendering instruction needs to be generated again for the virtual object.

Before the changed reflection capture object triggers a rendering process, rendering instructions of some virtual objects are selectively updated according to whether each virtual object within the field of view is affected by the reflection capture object, and rendering instructions of all virtual objects in the virtual scene do not need to be updated. This method can effectively reduce the number of rendering instructions that need to be updated, thereby reducing computing overheads when the rendering instructions are updated, reducing computing overheads during rendering to generate the display picture, shortening time consumed by generating the display picture, and improving smoothness of playing the display picture.

FIG. 6 is a flowchart of a picture rendering method according to an illustrative aspect described herein. For example, the method may be performed by the terminal device 10 in the solution implementation environment shown in FIG. 1. For example, the method may be performed by a client of a target application running on the terminal device 10. As shown in FIG. 6, the method may include the following operations (610-640):

Operation 610: Obtain reflection capture information of a virtual scene, where the reflection capture information includes geometric information of at least one reflection capture object, and the reflection capture object is configured for projecting a cube map representing a reflection effect onto a material surface of a virtual object.

The virtual scene is a digital scene delineated by a computer using a digital communication technology. The virtual scene may be understood as a digital three-dimensional space. The display picture of the target application comes from the virtual scene. For example, the display picture of the target application may be obtained by observing, through a virtual camera, the virtual scene provided by the target application.

In some aspects, the virtual scene includes a virtual object and a functional object. The virtual object is a visible object in the virtual scene. The functional object is an object that is provided in the virtual scene and configured for implementing an independent function, such as light, energy, and heat. In some cases, the functional object is invisible in the virtual scene. To be specific, the display picture does not display the functional object, the functional object may have an impact range in a virtual environment, and the impact range of the functional object is preset.

In some aspects, the virtual object includes: a game object that may be controlled by the terminal device to move, such as a virtual character, a virtual prop, or a virtual vehicle, and an environment object that cannot be controlled by the terminal device, such as a virtual prop, a virtual building, or a virtual mountain. The virtual object may be fixed at a position in the virtual scene, or may move in the virtual scene. To be specific, the virtual object may be understood as any object in the virtual scene that can appear in the display picture. This is not limited in this aspect described herein.

To distinguish display effects of different virtual objects, a virtual object has a material attribute, and a material of the virtual object is configured for simulating a real object corresponding to the virtual object. In some aspects, the material attribute of the virtual object is embodied by using a cube map on a material surface. The terminal device integrates the cube map to the material surface of the virtual object, so that a surface texture of the virtual object approaches a visual effect of the real object. For example, the cube map is a texture map that is organized in a cube structure and is combined and mapped by a plurality of textures. In some aspects, the cube map includes six two-dimensional maps. The six two-dimensional maps are respectively configured for representing surface textures of six surfaces, namely, upper, lower, left, right, front, and back, of the virtual object. For example, the cube map on the material surface of the virtual object may be preset, or may be determined in real time according to a position of the virtual object in the virtual scene.

The reflection capture object is an object determined based on a reflection capture technology. For example, the reflection capture object may be an object for simulating reflection and indirect illumination of a material and a scene, and may be dummy and does not exist in the virtual scene. In some aspects, the reflection capture object is configured for providing a cube map for a virtual object having a reflection attribute. In some aspects, the cube map provided by the reflection capture object comes from a first region in the virtual scene. The cube map provided by the reflection capture object is a static image obtained by observing the first region in the virtual scene at a first observation angle. The virtual object having the reflection attribute is an object that can reflect light and indirectly reflect light, such as a mirror surface, a water surface, or a glass surface. The cube map provided by the reflection capture object enables the virtual object having the reflection attribute to have a reflection effect. The first region is related to the virtual object having the reflection attribute. For example, the first region may be a region reached by target light. The target light may be light reflected by the virtual object having the reflection attribute at a first observation viewing angle.

To be specific, the reflection capture object is configured for projecting the cube map captured from the virtual scene onto a reflective material surface, to achieve an effect that landscape in the first region of the virtual scene, such as sky on a river surface, is reflected on the surface of the virtual object. The river surface is the reflective material surface, and the sky is the landscape in the first region. For example, the reflection capture object includes a probe for observing the first region in the virtual scene at the first observation angle, to obtain the cube map provided by the reflection capture object. Coordinate information of the probe and the first observation angle are preset. This is not limited described herein.

In some aspects, the reflection capture object has an impact range. The impact range of the reflection capture object is an effect-taking range of reflection capture, namely a range in which a cube map representing a reflection effect needs to be projected. The impact range of the reflection capture object is a part of a three-dimensional space in the virtual scene. A geometric shape of the impact range of the reflection capture object includes at least one of the following: a bounding box, a sphere, and a plane. Impact ranges of different reflection capture objects are not completely the same, and impact ranges of reflection capture objects of different geometric shapes are not completely the same.

The cube map provided by the reflection capture object needs to be mapped onto a surface of the virtual object located in the impact range of the reflection capture object, and the cube map provided by the reflection capture object does not need to be mapped onto a surface of the virtual object located outside the impact range of the reflection capture object. The material surface is a surface for indicating a material. The material is an expression of attributes such as texture, gloss, and transparency of the surface of the virtual object, and directly affects a visual effect and texture of the virtual object.

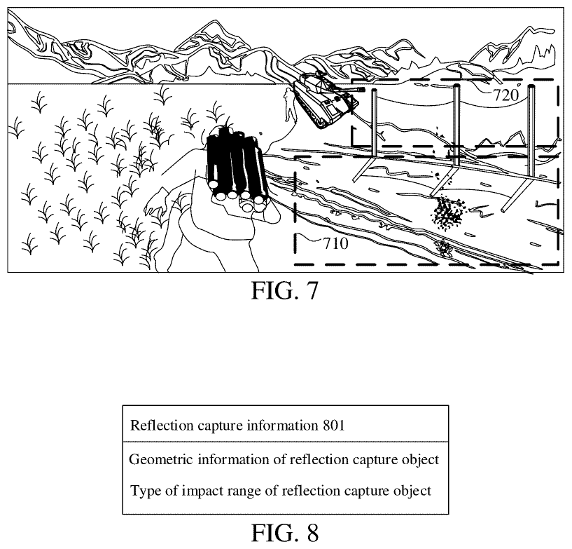

FIG. 7 is a schematic diagram of a reflection effect according to an illustrative aspect described herein. As shown in FIG. 7, a reflection capture object enables a surface texture of a virtual object to have a reflection effect. The surface texture of a virtual object 710 (a river) in a virtual scene includes a first region 720 from the virtual scene. To be specific, landscape (a static image) in the first region 720 is reflected on the virtual object 710, so that the surface texture of the virtual object 710 has a reflection effect.

In some aspects, the reflection effect of the reflection capture object includes at least one of the following: reflection effect-taking or reflection failure. The reflection effect-taking means that the terminal device loads the reflection capture object, so that the reflection capture object can provide a cube map. The reflection failure means that the terminal device unloads the reflection capture object, so that the reflection capture object fails.

In some aspects, that the reflection effect is changed means that the reflection effect of the reflection capture object is changed. That the reflection effect is changed includes: switching from reflection failure to reflection effect-taking, and switching from reflection effect-taking to reflection failure. For example, if the reflection takes effect, a static image corresponding to the first region may be determined as the cube map, which is projected onto the material surface of the virtual object. If the reflection fails, the cube map is not obtained, and the cube map is not projected onto the material surface of the virtual object.

For example, a moment at which the reflection effect of the reflection capture object is changed is related to a behavior, controlled by the terminal device, of a virtual character in the virtual scene. For example, after the virtual character moves into an impact range of a reflection capture object, the terminal device loads the reflection capture object. After the virtual character moves out of an impact range of a reflection capture object, the terminal device unloads the reflection capture object. For example, if a minimum distance between a current field of view and an impact range of a reflection capture object is less than or equal to a threshold, the terminal device loads the reflection capture object. If a minimum distance between a current field of view and an impact range of a reflection capture object is greater than a threshold, the terminal device unloads the reflection capture object. The threshold may be any positive real number.

For example, a moment at which the reflection effect of the reflection capture object is changed is preset. For example, the target application presets to unload a reflection capture object at a first moment, and the terminal device unloads the reflection capture object at the first moment. For another example, the target application presets to load a reflection capture object at a second moment, and the terminal device loads the reflection capture object at the first moment. The first moment and the second moment are any one of moments in a running process of the target application.

In some aspects, the reflection capture information is configured for representing information related to all reflection capture objects corresponding to the virtual scene. For example, the reflection capture information includes geometric information of all the reflection capture objects corresponding to the virtual scene. In some aspects, the reflection capture information is configured for representing information related to a reflection capture object having a reflection effect changed. For example, the reflection capture information includes geometric information of at least one reflection capture object having the reflection effect changed. In some aspects, the reflection capture information includes at least one of the following: an object identifier of the reflection capture object, and geometric information of the reflection capture object, where the object identifier of the reflection capture object is configured for uniquely identifying the reflection capture object, and the geometric information of the reflection capture object is configured for indicating the impact range of the reflection capture object in the virtual scene.

For example, in a case that the reflection capture information includes the geometric information of all the reflection capture objects corresponding to the virtual scene, in the target application, a logical thread responsible for managing execution logic related to the virtual scene updates the reflection capture information when loading or unloading of the reflection capture information is detected. If reflection effects of a plurality of reflection capture objects are changed at a moment, the logical thread updates geometric information of the plurality of reflection capture objects to reflection capture information, to obtain updated reflection capture information. For another example, in a case that the reflection capture information includes geometric information of at least one reflection capture object having a reflection effect changed, in the target application, a logic thread responsible for managing execution logic related to the virtual scene records the reflection capture information when loading or unloading of the reflection capture information is detected. If reflection effects of a plurality of reflection capture objects are changed at a moment, the logical thread records geometric information of the plurality of reflection capture objects, to obtain reflection capture information. This is not limited in this aspect described herein.

In some aspects, the logical thread records the reflection capture information in a first array. Each array unit of the first array includes geometric information of one reflection capture object and an object identifier of the reflection capture object. Alternatively, each array unit of the first array includes geometric information of one reflection capture object having a reflection effect changed and an object identifier of the reflection capture object.

Operation 620: Determine, in the presence of a target reflection capture object having the reflection effect changed in the at least one reflection capture object, at least one target virtual object from at least one virtual object included in a field of view according to the geometric information of the target reflection capture object, where the target virtual object is a virtual object having a surface display effect changed when the reflection effect of the target reflection capture object is changed. As used herein, “in the presence of” may refer to the subject being within a field of view, or an object whose light reflection properties may affect one or more objects within the field of view.

In some aspects, if the reflection capture object is switched from reflection failure to reflection effect-taking or from reflection effect-taking to reflection failure, the reflection capture object may be determined as a target reflection capture object. Geometric information of the target reflection capture object may be obtained by obtaining the reflection capture information in operation 610.

In some aspects, in a case that the reflection capture information includes geometric information of at least one reflection capture object having a reflection effect changed, the at least one reflection capture object is a target reflection capture object. To be specific, any reflection capture object corresponding to the reflection capture information is a reflection object having a reflection effect changed in the virtual scene. Geometric information of any one reflection capture object is obtained by obtaining the reflection capture information in operation 610. In some aspects, the reflection capture information includes the geometric information of the reflection capture object.

In some aspects, the field of view is configured for representing a range for observing a virtual scene, and a virtual object in the field of view in the virtual scene can be observed. A virtual object not in the field of view cannot be observed. To be specific, the virtual object in the field of view can appear in the display picture of the field of view, and a virtual object not in the field of view does not appear in the display picture of the field of view. The field of view may be understood as an observation range of a virtual camera in the virtual scene. To be specific, the field of view is a geometric region included in a frustum using an imaging center of the virtual camera as a vertex.

In some aspects, the field of view is changed with movement of the virtual camera. Therefore, the fields of view at different moments may be different. The virtual object included in the field of view is also changed at different moments. For example, at a kth moment, the field of view includes a virtual object 1, a virtual object 2, and a virtual object 3. At a (k+1)th moment, the field of view includes a virtual object 3 and a virtual object 4, where k is a positive integer.

For example, a type of the field of view includes at least one of the following: a field of view under a first-person perspective, a field of view under a third-person perspective, a field of view under a God's perspective, and a field of view under a 45-degree perspective. The field of view under the first-person perspective is an observation range in which a controllable virtual character is used as an observer to observe the virtual scene. In this case, the display picture of the field of view is configured for representing a picture observed by the virtual character. For example, if a virtual camera is disposed at a position of a head of a virtual character in a virtual scene, the virtual camera and the head of the virtual character are relatively stationary, and a photographing direction of the virtual camera is the same as a line-of-sight direction of the virtual character, a photographing range of the virtual camera is a field of view.

No virtual character or a part of a virtual character (for example, only a hand of the virtual character and no face of the virtual character appear in a display picture) appears in the display picture obtained after the virtual scene is observed from the field of view under the first-person perspective. The virtual scene is observed by using the first-person perspective to obtain the display picture, so that a feeling of immersion of the user in the target application can be improved.

The third-person perspective is a perspective at which the virtual character is followed to observe the virtual scene. In some aspects, the virtual character can be observed from the third-person perspective. The third-person perspective may be understood as that a virtual camera is disposed at a first distance from the virtual character, and the virtual camera and a first virtual character remain stationary relative to each other. The first distance may be set and adjusted according to an actual use requirement. A method for setting a field of view is set according to an actual requirement. This is not limited described herein.

In some aspects, the target virtual object is: a virtual object located in an impact range of the target reflection capture object among virtual objects included in the field of view. A surface material of the target virtual object has a reflection attribute. For example, the surface material of the target virtual object is a water surface material, a glass material, a metal plane material, or the like.

In an example, the terminal device determines an impact range corresponding to each reflection capture object according to geometric information of each reflection capture object in the reflection capture information. In the presence of one or more target reflection capture objects, for any target reflection capture object, the terminal device determines, from the at least one virtual object included in the field of view, a target virtual object located in an impact range of the target reflection capture object. The terminal device records target virtual objects respectively corresponding to the target reflection capture objects.

In some aspects, after the reflection effect of the reflection capture object is changed, a texture of a material surface of the target virtual object needs to be synchronously changed. For example, after a reflection capture object is loaded by the terminal device, a cube map provided by the reflection capture object needs to be displayed in a surface texture of a target virtual object corresponding to the reflection capture object. For another example, after a reflection capture object is unloaded by the terminal device, a cube map provided by the reflection capture object is not required to appear in a surface texture of a target virtual object corresponding to the reflection capture object.

Therefore, in the presence of a target reflection capture object having a reflection effect changed, these target virtual objects need to be re-rendered, so as to update surface textures of the target virtual objects in a display picture.

In some aspects, operation 620 is performed by a render thread in the target application. In some aspects, the render thread accesses a logical thread according to a first time interval, and obtains reflection capture information from the logical thread. The render thread determines, according to the reflection capture information, at least one target reflection capture object having a reflection effect changed, and respectively determines target virtual objects corresponding to the target reflection capture objects. The first time interval may be set and adjusted according to an actual use requirement. For details of the method for determining a target virtual object, refer to the following aspects.

Operation 630: Re-render the target virtual object to generate a re-rendered target virtual object, where a texture of the material surface of the re-rendered target virtual object is changed.

Re-rendering is a process of rendering a virtual object again. The re-rendered target virtual object is a target virtual object obtained after re-rendering. In some aspects, the re-rendering in this aspect described herein may be a process of rendering the material surface of the virtual object again. In some aspects, the terminal device re-renders the target virtual object to generate a target virtual object having a material surface texture changed, namely a re-rendered target virtual object. For virtual objects other than the target virtual object in the field of view, the terminal device also renders these virtual objects. However, material surface textures of these virtual objects are not affected by the target reflection capture object and are not changed. To be specific, there is no need to render material surfaces of these objects, thereby reducing workload of re-rendering, and further improving re-rendering efficiency.

In some aspects, in this operation, the terminal device updates a rendering instruction of the target virtual object, and does not need to update rendering instructions of virtual objects other than the target virtual object. Therefore, the workload of updating the rendering instruction can be reduced. The terminal device performs a rendering process according to the rendering instruction of the target virtual object and non-updated rendering instructions of other virtual objects.

For example, in a process of generating a display picture, a rendering instruction of each virtual object included in the field of view needs to be used. After a display picture is generated, the terminal device temporarily stores a rendering instruction of each virtual object. When a next display picture needs to be rendered, the terminal device performs operations 610 and 620 of determining a target virtual object in the next display picture. The terminal device updates a rendering instruction of a target virtual object in the next display picture (which may alternatively be understood as replacing an old rendering instruction of the target virtual object with the updated rendering instruction of the target virtual object). Subsequently, the terminal device instructs, according to the updated rendering instruction of the target virtual object and non-updated rendering instructions of other virtual objects, a graphics processing unit to render each virtual object included in the field of view. After a next display picture is generated through rendering, the terminal device stores an updated rendering instruction of the target virtual object and non-updated rendering instructions of other virtual objects.

Operation 640: Generate a display picture of the field of view according to the re-rendered target virtual object and virtual objects other than the target virtual object in the at least one virtual object.

The display picture of the field of view may be a picture obtained through observation for a region of the virtual scene located within the field of view. The display picture includes a re-rendered target virtual object and other virtual objects within the field of view. In some aspects, the display picture may be a 2 dimensional (2D) planar image, or may be a 3 dimensional (3D) picture that has a three-dimensional structure and a perspective relationship. Aspects described herein do not limit the type of the display picture. For example, the display picture includes a two-dimensional planar image of the re-rendered target virtual object and a two-dimensional planar image of another virtual object.

In an example, an example in which the target application is a game application is used. The virtual scene is configured for providing a game picture. The terminal device controls, in response to a moving operation on a virtual character, the virtual character to move in the virtual scene. At a moment, a field of view of the virtual character coincides with an impact range of a reflection capture object A. The terminal device loads the reflection capture object A. The terminal device obtains geometric information of the reflection capture object A, and determines, from at least one virtual object included in the field of view according to the geometric information of the reflection capture object A, at least one target virtual object affected by the reflection capture object A. The terminal device re-renders the at least one target virtual object, so that a material surface of the re-rendered target virtual object displays a cube map provided by the reflection capture object A. The terminal device generates a next display picture according to the target virtual object and another virtual object in the field of view.

In conclusion, in a case that a reflection effect of a reflection capture object is changed, a virtual object affected by the reflection capture object is selected from virtual objects included in a field of view, and only a rendering instruction of the selected virtual object is updated, so that the number of updated rendering instructions can be effectively reduced. In this manner, the problem of a computing pressure rise caused by updating the rendering instruction when the reflection effect of the reflection capture object is changed is reduced, thereby reducing power consumption of a terminal device.

In addition, by reducing the number of virtual objects needing to be updated and rendered, a computing pressure in a process of generating a display picture by the terminal device when the reflection effect of the reflection capture object is changed is reduced, thereby reducing a probability that a picture frame freezing problem occurs. Therefore, a frame rate at which the display picture is updated keeps stable, thereby improving rendering performance of the terminal device, and maintaining smoothness of the display picture in a use process of a target application.

The method for obtaining reflection capture information is described below by using several aspects.

In some aspects, operation 610 of obtaining reflection capture information of a virtual scene may include the following sub-operations.

Sub-operation 613: The terminal device generates the reflection capture information by using a logical thread, where the logical thread is configured for managing a logical operation related to the virtual scene.

In some aspects, the terminal device generates reflection capture information by using a logical thread and updates the reflection capture information when the reflection effect of the reflection capture object is changed.

In some aspects, when the reflection effect of the reflection capture object is changed, the terminal device generates the reflection capture information by using the logical thread. To be specific, corresponding to different moments, if the reflection effect of the reflection capture object is changed, different reflection capture information is generated.

For example, the reflection effect of the reflection capture object may be changed by calling an effect change function. After receiving the called effect change function, the logical thread may determine that the reflection effect of the reflection capture object is changed. The logical thread records geometric information of the reflection capture object and generates the reflection capture information or updates the reflection capture information according to the geometric information of the reflection capture object. The reflection capture information includes geometric information of all reflection capture objects having reflection effects changed in a next frame of display picture. In some aspects, in a case that the target application is a game application, the logical thread is alternatively referred to as a game thread.

FIG. 8 is a schematic diagram of reflection capture information according to an illustrative aspect described herein. The reflection capture information 801 includes a type of an impact range of a reflection capture object, for example, types such as a bounding box, a sphere, or planar, and geometric information of the reflection capture object, for example, position information and size information of the impact range in the virtual scene.

Sub-operation 616: The terminal device obtains the reflection capture information from the logical thread by using a render thread according to an access period, where the render thread is configured for generating the display picture of the field of view through rendering.

In some aspects, the access period is related to a frame rate of the display picture. The frame rate is the number of the display picture per unit time. For example, the access period is equal to a reciprocal of the frame rate of the display picture.

In some aspects, the render thread determines, every other access period, whether a reflection effect of each reflection capture object included in the virtual scene is changed. If at least one target reflection capture object having a reflection effect changed exists in the virtual scene, the render thread obtains the reflection capture information from the logical thread to obtain geometric information of the at least one target reflection capture object, to determine a target virtual object in the field of view. If a target reflection capture object having a reflection effect changed does not exist in the virtual scene, the operation of determining a target virtual object in the field of view does not need to be performed.

For example, the render thread determines, by accessing a storage address used by the logical thread for storing the reflection capture information, whether there is a target reflection capture object having a reflection effect changed. If the storage address is null, the render thread determines that the reflection effect of the reflection capture object is not changed. If the storage address is not null, the render thread determines that the reflection effect of the reflection capture object is changed. In this case, the render thread reads the reflection capture information from the storage address. Alternatively, the render thread determines, according to an effect change function, whether there is a target reflection capture object having a reflection effect changed. If there is no effect change function, the render thread determines that the reflection effect of the reflection capture object is not changed. If the effect change function exists, the render thread determines that the reflection effect of the reflection capture object is changed. In this case, the render thread reads the geometric information of the target reflection capture object from the reflection capture information.

In some aspects, the terminal device needs to generate display pictures at different moments according to a frame rate. Therefore, in a running process of the target information program, the render thread needs to determine a rendering instruction of each virtual object in a field-of-view scene. For a moment at which the reflection effect of the reflection capture object is changed, before the render thread obtains the reflection capture information from the logical thread according to the access period, the render thread performs frustum culling and occlusion query on virtual objects included in the virtual scene, to determine a virtual object in the field of view among the virtual objects included in the virtual scene. Subsequently, the render thread obtains the geometric information of the target reflection capture object from the logical thread, and determines at least one target virtual object according to the geometric information of the target reflection capture object.

According to the foregoing method, an optimization operation such as frustum culling is first performed before a target object is determined, thereby reducing the number of virtual objects needing to be verified whether the virtual objects are affected by a target reflection capture object and reducing computing overheads of determining a target virtual object by a render thread, to improve rendering performance of a terminal device. In addition, only geometric information of the target reflection capture object is obtained, and geometric information of all reflection capture objects does not need to be obtained, thereby reducing workload of obtaining the geometric information, and further reducing power consumption of the terminal device.

The method for determining a target virtual object is described below by using several aspects.

The terminal device determines at least one target virtual object from at least one virtual object included in a field of view according to an impact range of a target reflection capture object. In some aspects, a virtual object located within the impact range of the target reflection capture object is determined as the target virtual object, and a virtual object located outside the impact range of the target reflection capture object is not determined as the target virtual object. A process of determining a position relationship between a virtual object and the impact range of the target reflection capture object includes the following content.

In some aspects, operation 620 of determining at least one target virtual object from at least one virtual object included in a field of view according to the geometric information of the target reflection capture object may further include the following several sub-operations (not shown in the drawings).

Sub-operation 623a: Calculate a first bounding volume of the target reflection capture object according to the geometric information of the target reflection capture object, where the first bounding volume is a geometric space in which the target reflection capture object takes effect in the virtual scene.

In some aspects, the first bounding volume is configured for representing an impact range of the reflection capture object in the virtual scene. In some cases, the impact range of the reflection capture object in the virtual scene is a closed geometric body. In some aspects, a type of the first bounding volume includes at least one of the following: a cuboid bounding box and a sphere.

For example, if the impact range of the reflection capture object is a cuboid bounding box, the geometric information of the reflection capture object is configured for representing vertex information of the impact range of the reflection capture object. If the geometric information of the target reflection capture object is configured for representing position information of eight vertexes of the bounding box, a range corresponding to a cuboid constructed based on the eight vertexes is the impact range of the target reflection capture object. If the impact range of the reflection capture object is a sphere, the geometric information of the reflection capture object is configured for representing dot coordinate information and a radius of the reflection capture object. If the geometric information of the target reflection capture object is configured for representing dot coordinate information and a radius of the sphere, a range corresponding to the sphere is the impact range of the target reflection capture object. The terminal device can calculate the impact range of the reflection capture object, namely the first bounding volume of the reflection capture object according to the geometric information of the reflection capture object.

Sub-operation 626a: Determine the at least one target virtual object according to the first bounding volume and a second bounding volume corresponding to the at least one virtual object, where the second bounding volume is a geometric space occupied by the virtual object in the virtual scene.

In some aspects, the second bounding volume is configured for representing a position of the virtual object in the virtual scene. In some aspects, a type of the second bounding volume includes at least one of the following: a cuboid bounding box and a sphere.

In some aspects, if the virtual object is an immovable virtual object, the second bounding volume of the virtual object is preset. The terminal device directly reads coordinate information of the second bounding volume of the virtual object from a storage space. If the virtual object is a movable virtual object, a position of the second bounding volume of the virtual object in the virtual scene is changed. The terminal device calculates coordinate information of the second bounding volume in the virtual scene according to initial coordinate information of the second bounding volume and movement information of the virtual object. The initial coordinate information is configured for indicating an initial position of the virtual object in the virtual scene. The movement information is configured for representing a movement situation of the virtual object in the virtual scene.

In some aspects, for any virtual object, the terminal device determines whether to use the virtual object as a target virtual object according to a position relationship between the first bounding volume and the second bounding volume of the virtual object. If the position relationship between the second bounding volume and the first bounding volume of the virtual object satisfies an intersection condition, it may be determined that the virtual object is affected by the target reflection capture object, and the virtual object is determined as a target virtual object. If the position relationship between the second bounding volume and the first bounding volume of the virtual object does not satisfy the intersection condition, it may be determined that the virtual object is not affected by the target reflection capture object, and the virtual object is not determined as a target virtual object. The intersection condition is configured for verifying an intersection situation of the first bounding volume and the second bounding volume in the virtual scene. The intersection situation is configured for indicating whether the first bounding volume intersects the second bounding volume.

A target virtual object is searched for in at least one virtual object included in an impact range, so that only a rendering instruction of the target virtual object is updated subsequently. According to this method, when a reflection effect of a reflection capture object is changed, the target virtual object having a surface texture changed can be displayed in a display picture, and the number of rendering instructions needing to be updated can be effectively controlled, thereby improving rendering efficiency of the terminal device, and reducing waste of computing resources.

The method for determining whether bounding volumes intersect with each other (i.e. whether the bounding volumes satisfy the intersection condition) is described below by using several aspects.

In some aspects, sub-operation 626a that the terminal device determines the at least one target virtual object according to the first bounding volume and a second bounding volume corresponding to the at least one virtual object includes: determining, for any to-be-detected bounding volume in the second bounding volume corresponding to the at least one virtual object, a virtual object corresponding to the to-be-detected bounding volume as the target virtual object if the to-be-detected bounding volume intersects with the first bounding volume.

In some aspects, the render thread sequentially determines whether the second bounding volume corresponding to at least one virtual object intersects with the first bounding volume. The to-be-detected bounding volume is a second bounding volume, where it is not determined whether the second bounding volume overlaps with the first bounding volume. For example, the terminal device determines, one by one, whether the to-be-detected bounding volume intersects with the first bounding volume. If a to-be-detected bounding volume intersects the first bounding volume, the terminal device determines a virtual object corresponding to the to-be-detected bounding volume as the target virtual object. If a to-be-detected bounding volume does not intersect with the first bounding volume, the terminal device determines that a virtual object corresponding to the to-be-detected bounding volume is not the target virtual object.

In some aspects, the method for determining whether the to-be-detected bounding volume and the first bounding volume intersect with each other is related to the shape of the first bounding volume (i.e. the shape of the impact range of the reflection capture object). If the impact range of the reflection capture object is a closed space, the first bounding volume may be a cuboid bounding box or a sphere. The method for determining whether the first bounding volume intersects the second bounding volume intersect in a case that the first bounding volume is a cuboid bounding box and the first bounding volume is a sphere is described below by using two examples.

Example 1: The first bounding volume is a cuboid bounding box.

In some aspects, the picture rendering method further includes: The terminal device calculates a first normal vector group of the first bounding volume according to vertex information of the first bounding volume in a case that the first bounding volume is a cuboid and the to-be-detected bounding volume is a cuboid, where the first normal vector group includes a first normal vector perpendicular to a plane of the first bounding volume. The terminal device determines a second normal vector group of the to-be-detected bounding volume according to vertex information of the to-be-detected bounding volume, where the second normal vector group includes a second normal vector perpendicular to a plane of the to-be-detected bounding volume. The terminal device calculates a cross product vector between two normal vectors respectively from the first normal vector group and the second normal vector group, where the cross product vector is a result vector obtained by vector cross multiplication. The terminal device sets the first normal vector, the second normal vector, and the cross product vector as k separation axes between the first bounding volume and the to-be-detected bounding volume, where k is a positive integer. The terminal device determines an intersection situation between the first bounding volume and the to-be-detected bounding volume according to projections of the first bounding volume and the to-be-detected bounding volume on the k separation axes, where the intersection situation is configured for indicating whether the first bounding volume intersects with the to-be-detected bounding volume.

In some aspects, the vertex information of the first bounding volume is determined according to geometric information of the target reflection capture object. In some aspects, the geometric information of the target reflection capture object includes coordinate information of a center point of the first bounding volume and a side length of each point of the first bounding volume. The terminal device calculates coordinate information of eight vertexes of the first bounding volume according to the coordinate information of the center point of the first bounding volume and the side length of each point of the first bounding volume. For example, the eight vertexes are respectively A1, A2, A3, A4, A5, A6, A7, and A8.

In some aspects, that the terminal device calculates a first normal vector group of the first bounding volume according to vertex information of the first bounding volume includes: The terminal device determines three base vectors of the first bounding volume, where the base vector is configured for representing a side length direction of the first bounding volume. The terminal device selects any two base vectors from the three base vectors. The terminal device calculates a cross product of the two selected base vectors, to obtain a first normal vector perpendicular to a plane of the first bounding volume.

In some aspects, according to a basic geometrical relationship, the cuboid includes six surfaces. Three groups of surfaces parallel to each other exist in the six surfaces. Normal vectors of the surfaces parallel to each other are the same. To be specific, the cuboid has three normal vectors that are not parallel to each other, which are respectively denoted as NA1, NA2, and NA3. The cuboid has side lengths of three directions. To be specific, the cuboid has three base vectors. For any base vector among the three base vectors, the base vector may be calculated according to a difference between coordinates of two vertexes on the side length corresponding to the base vector of the cuboid. The base vectors in the three directions may be respectively denoted as U1, V1, and W1.

The first normal vector group is a set or group of first normal vectors. For example, the first normal vector group includes first normal vectors of three different directions: NA1, NA2, and NA3, which may be respectively calculated by using the following formulas: NA1=U1×V1, NA2=W1×V1, and NA3=W1×U1.

The second normal vector group is a set or group of second normal vectors. The method for calculating the second normal vector group is the same as the method for calculating the first normal vector group. For example, eight vertexes of the second bounding volume are respectively B1, B2, B3, B4, B5, B6, B7, and B8. Three base vectors U2, V2, and W2 of the second bounding volume may be calculated by using the eight vertexes of the second bounding volume. The terminal device separately performs cross multiplication on any two base vectors among the three base vectors of the second bounding volume, to obtain three second normal vectors included in the second bounding volume: NB1, NB2, and NB3, where NB1=U2×V2, NB2=W2×V2, and NB3=W2×U2. To be specific, the second normal vector group includes second normal vectors of three different directions: NB1, NB2, and NB3.

After obtaining the first normal vector group and the second normal vector group through calculation, the terminal device calculates a separation axis according to normal vectors in the first normal vector group and the second normal vector group. In some aspects, the separation axis includes two types. The first type of separation axis is a normal vector of the first bounding volume or a normal vector of the second bounding volume. To be specific, NA1, NA2, NA3, NB1, NB2, and NB3 all belong to the first type of separation axis. The second type of separation axis is obtained through calculation by using a normal vector in the first normal vector group and a normal vector in the second normal vector group.

For example, each separation axis in the second type of separation axis may be denoted as: N11, N12, N13, N21, N22, N23, N31, N32, and N33, where N11=NA1×NB1, N12=NA1×NB2, N13=NA1×NB3, N21=NA2×NB1, N22=NA2×NB2, N23=NA2×NB3, N31=NA3×NB1, N32=NA3×NB2, and N33=NA3×NB3. To be specific, the terminal device can calculate 15 separation axes, which are respectively: NA1, NA2, NA3, NB1, NB2, NB3, N11, N12, N13, N12, N22, N23, N31, N32, and N33.

In some aspects, that the terminal device determines an intersection situation between the first bounding volume and the to-be-detected bounding volume according to projections of the first bounding volume and the to-be-detected bounding volume on the k separation axes includes: The terminal device calculates, for any one separation axis among the k separation axes, a first projection line of the first bounding volume on the separation axis, and a second projection line of the second bounding volume on the separation axis. The terminal device determines, according to an overlapping degree between the first projection line and the second projection line, whether the first bounding volume and a to-be-detected bounding volume overlap.

In some aspects, if there is one first separation axis and a first projection line on the first separation axis and a second projection line do not overlap, the terminal device determines that the to-be-detected bounding volume does not intersect with the first bounding volume. If the first projection line and the second projection line overlap on the k separation axes, the terminal device determines that the to-be-detected bounding volume intersects the first bounding volume.

To be specific, in a process of determining an intersection situation between the first bounding volume and the to-be-detected bounding volume according to projections of the first bounding volume and the to-be-detected bounding volume on the k separation axes, the terminal device determines whether a first separation axis exists in the k separation axes. The first separation axis is a separation axis on which a first projection line and a second projection line do not overlap. If a separation axis belongs to the first separation axis, the terminal device stops verifying another separation axis, and determines that the first bounding volume does not intersect the to-be-verified bounding volume. If the first separation axis does not exist, the terminal device continues to verify whether another separation axis is the first separation axis until the process of verifying the k separation axes is completed. If the k separation axes do not include the first separation axis, the terminal device determines that the first bounding volume intersects with the to-be-detected bounding volume.

In this aspect described herein, by using a “separation axis” method, whether the first bounding volume intersects the to-be-detected bounding volume may be quickly determined, thereby effectively improving efficiency of determining an intersection situation, and further improving efficiency of determining the target virtual object.

Example 2: The first bounding volume is a sphere.

In some aspects, the picture rendering method further includes: determining a base vector group of the to-be-detected bounding volume according to vertex information of the to-be-detected bounding volume in a case that the first bounding volume is a sphere and the to-be-detected bounding volume is a cuboid, where the base vector group includes a base vector for representing a side length direction of the to-be-detected bounding volume; projecting, according to coordinate information of a center point of the first bounding volume, the center point onto the base vector, and calculating coordinate information of a target position point nearest to the center point in the second bounding volume; and determining an intersection situation between the first bounding volume and the to-be-detected bounding volume according to the coordinate information of the center point, the coordinate information of the target position point, and a radius of the first bounding volume, where the intersection situation is configured for indicating whether the first bounding volume intersects with the to-be-detected bounding volume.

In some aspects, the base vector group of the to-be-detected bounding volume includes three base vectors. For the method for determining base vectors in the base vector group of the to-be-detected bounding volume, refer to the foregoing aspect.

In some aspects, that the terminal device projects, according to coordinate information of a center point of the first bounding volume, the center point onto the base vector, and calculates coordinate information of a target position point nearest to the center point in the second bounding volume includes: The terminal device calculates linear distances between the center point of the first bounding volume and the base vectors, and determines a minimum distance from the linear distances with the base vectors. The target position point is a projection point nearest to the center point on the base vector. A connection line between the base vector and the target position point is perpendicular to the base vector.

Subsequently, the terminal device calculates a distance between the target position point and the center point according to the coordinate information of the target position point and the coordinate information of the center point. The terminal device determines, according to the radius of the first bounding volume, the distance between the target position point and the center point, and the radius of the first bounding volume, whether the first bounding volume intersects the second bounding volume.

In some aspects, the terminal device determines that the first bounding volume does not intersect the second bounding volume if the radius of the first bounding volume and the distance between the target position point and the center point are greater than the radius of the first bounding volume. The terminal device determines that the first bounding volume intersects the second bounding volume if the radius of the first bounding volume and the distance between the target position point and the center point are less than or equal to the radius of the first bounding volume.

In a case that the first bounding volume is a sphere, in this aspect described herein, whether the first bounding volume intersects the to-be-detected bounding volume may be determined based on the center point and the radius of the first bounding volume, and the base vector group of the to-be-detected bounding volume, thereby reducing computation required for determining an intersection situation, and further reducing computation required for determining the target virtual object.

In a case that the field of view of the virtual scene includes a large number of virtual objects, it takes time for the terminal device to determine the target virtual object. To improve efficiency of determining the target virtual object by the terminal device, the time consumed for determining the target virtual object is shortened. The operation of determining a target virtual object concurrently is described below by using several aspects.

In some aspects, the operation that the terminal device determines at least one target virtual object is performed by a render thread. The render thread includes a plurality of sub-threads. Operation 620 of determining the at least one target virtual object according to the first bounding volume and a second bounding volume corresponding to the at least one virtual object includes the following sub-operations.

Sub-operation 623b: Calculate, for any sub-thread among the plurality of sub-threads, a second bounding volume corresponding to each virtual object in a virtual object subset by using the sub-thread, where the virtual object subset includes m virtual objects in the at least one virtual object, and m is a positive integer.

In some aspects, the sub-thread is a thread for executing rendering logic. That the render thread includes a plurality of sub-threads may be understood as that the terminal device is provided with a plurality of Render threads for executing the rendering logic. The sub-threads have independent computing resources and storage resources. To be specific, execution logic of the sub-threads does not interfere with each other.

In some aspects, the number of sub-threads created by the terminal device is related to the configuration of the terminal device. For example, if the terminal device has a multi-core processor and the multi-core processor includes n CPUs, the terminal device creates m sub-threads, where n is a positive integer, and m is a positive integer less than or equal to n. The terminal device concurrently screens the virtual objects in the field of view by using the m sub-threads, to determine at least one target virtual object.

In some aspects, each sub-thread corresponds to one virtual object subset. To be specific, the virtual objects are divided according to the number of sub-threads. For example, in a case that the field of view includes a plurality of virtual objects, the terminal device groups the plurality of virtual objects, to obtain m virtual object subsets. Each virtual object subset includes at least one virtual object. To be specific, a value of m is less than or equal to the number of virtual objects included in the field of view.

In some aspects, different virtual object subsets include different virtual objects. To be specific, for any virtual object among the plurality of virtual objects in the field of view, the virtual object can be included in only one virtual object subset. By means of this method, it is ensured that each virtual object needs to be checked for only once, thereby saving computing resources of the terminal device.

In some aspects, the terminal device performs static division on a plurality of virtual objects in the field of view, to obtain m virtual object subsets. In some aspects, a number difference between of virtual objects included in each virtual object subset among the m virtual object subsets is at most t, where t is a natural number, and t may be set and adjusted according to an actual use requirement. The static division means that a virtual object processed by each sub-thread is fixed.

For example, a field of view at a moment includes p virtual objects. The terminal device evenly divides the p virtual objects, to obtain m virtual object subsets, and respectively allocates the m virtual object subsets to m sub-threads, so that the sub-threads respectively simultaneously detect whether target objects exist in the respectively allocated virtual object subsets. Alternatively, in batches, whether target objects exist in the respectively allocated virtual object subsets is detected by using the sub-threads.

If p is exactly divisible by m, the number of virtual objects included in any virtual object subset in each virtual object subset is p/m. If p cannot be exactly divided by m, the m virtual object subsets include (m−1) virtual object subsets. The (m−1) virtual object subsets separately include p/m virtual objects. A virtual object subset other than the (m−1) virtual object subsets includes p % m virtual objects, where % is a remainder operation. In this division manner, the plurality of virtual objects included in the field of view can be simply divided into the virtual object subsets corresponding to the sub-threads.

In some aspects, the terminal device performs dynamic division on a plurality of virtual objects in the field of view, to obtain m virtual object subsets. The dynamic division means that a virtual object processed by each sub-thread is variable.

In some aspects, the terminal device divides a plurality of virtual objects into a plurality of static subsets and a dynamic subset. Any two static subsets do not include a same virtual object, and any static subset and the dynamic subset do not include a same virtual object. In some aspects, the number of static subsets is equal to the number of sub-threads created by the terminal device, and the number of virtual objects included in each static subset is the same. In some aspects, the static subset includes at least one virtual object.

For example, a field of view at a moment includes p virtual objects. The terminal device selects q virtual objects from the p virtual objects. The dynamic subset includes the q virtual objects. The terminal device divides the remaining (p-q) virtual objects into m static subsets, and allocates the m static subsets to m sub-threads, where m is a positive integer less than or equal to n, and n is the number of CPUs included in the multi-core processor. The terminal device respectively configures the m static subsets to the m sub-threads. If a first sub-thread among the m sub-threads completes a process of checking each virtual object in the first static subset at moment t1, and at least a second sub-thread still exists among the m sub-threads and does not complete a process of checking each virtual object in the second static subset, the first sub-thread obtains at least one first virtual object from the dynamic subset, and deletes the obtained first virtual object from the dynamic subset. The first sub-thread performs a verification process on the at least one first virtual object obtained from the dynamic subset.

The first sub-thread and the second sub-thread are both sub-threads among the m sub-threads. The first static subset is a static subset allocated to the first sub-thread. The second subset is a static subset allocated to the second sub-thread. If the first virtual object is a target object, the first sub-thread adds the first virtual object to an object queue of the first sub-thread. For details of the object queue, refer to the following aspects. In a case that the m sub-threads complete a verification process of each virtual object in a corresponding static subset and the dynamic subset does not include a virtual object, the m sub-threads complete a verification process of a virtual object included in the field of view.

In a case that the forms of the first bounding volume of the target reflection capture object are different, algorithms for verifying whether the first bounding volume intersects the to-be-verified bounding volume are different. To be specific, for different virtual objects, time consumption of determining whether the second bounding volume intersects the first bounding volume of the virtual object intersect is different. By dynamically dividing a plurality of virtual objects included in a field of view, a time difference between a plurality of sub-threads completing a process of verifying respective virtual objects can be reduced, and a case in which a minority of sub-threads need to complete a process of checking the virtual object while a majority of sub-threads complete the process of checking the virtual object is avoided, thereby further increasing a speed of determining the target virtual object, and reducing rendering time consumption generated by introducing this method.

Sub-operation 626b: The sub-thread adds, for a to-be-detected bounding volume corresponding to a to-be-detected virtual object in the virtual object subset, a virtual object corresponding to the to-be-detected bounding volume to an object queue if the to-be-detected bounding volume intersects with the first bounding volume, where the object queue includes a target virtual object in the virtual object subset.

The method used by each sub-thread to determine whether the first bounding volume intersects the second bounding volume is related to the shape of the first bounding volume. In some aspects, the picture rendering method further includes: The sub-thread calculates a first normal vector group of the first bounding volume according to vertex information of the first bounding volume in a case that the first bounding volume is a cuboid and the to-be-detected bounding volume is a cuboid, where the first normal vector group includes a first normal vector perpendicular to a plane of the first bounding volume. The sub-thread determines a second normal vector group of the to-be-detected bounding volume according to vertex information of the to-be-detected bounding volume, where the second normal vector group includes a second normal vector perpendicular to a plane of the to-be-detected bounding volume. The sub-thread calculates a cross product vector between two normal vectors respectively from the first normal vector group and the second normal vector group, where the cross product vector is a result vector obtained by vector cross multiplication. The sub-thread sets the first normal vector, the second normal vector, and the cross product vector as k separation axes between the first bounding volume and the to-be-detected bounding volume, where k is a positive integer. An intersection situation between the first bounding volume and the to-be-detected bounding volume is determined according to projections of the first bounding volume and the to-be-detected bounding volume on the k separation axes.

In some aspects, the picture rendering method further includes: The sub-thread determines a base vector group of the to-be-detected bounding volume according to vertex information of the to-be-detected bounding volume in a case that the first bounding volume is a sphere and the to-be-detected bounding volume is a cuboid, where the base vector group includes a base vector for representing a side length direction of the to-be-detected bounding volume. The sub-thread projects, according to coordinate information of a center point of the first bounding volume, the center point onto the base vector, and calculates coordinate information of a target position point nearest to the center point in the second bounding volume. The sub-thread determines an intersection situation between the first bounding volume and the to-be-detected bounding volume according to the coordinate information of the center point, the coordinate information of the target position point, and a radius of the first bounding volume.

For specific operations of the foregoing two aspects, refer to the foregoing aspect.

Sub-operation 629b: Combine, after the plurality of sub-threads respectively determine object queues, the object queues of the sub-threads, to obtain the at least one target virtual object.

In some aspects, the terminal device combines the target virtual objects respectively detected by the plurality of sub-threads, to obtain all target virtual objects affected by the target reflection capture object.

By means of this method, time consumption of determining a target virtual object in a plurality of virtual objects included in a field of view is reduced, thereby improving generation efficiency of generating a display picture.

In some aspects, if the target reflection capture object is a specular reflection object, the geometric information of the target reflection capture object includes an effect-taking direction for performing specular reflection. The effect-taking direction is a projection direction of the cube map. That the terminal device determines at least one target virtual object from at least one virtual object included in a field of view according to the geometric information of the target reflection capture object includes: The terminal device determines, as the at least one target virtual object, a virtual object included in an overlapping manner in some scenes corresponding to the field of view and the effect-taking direction of the specular reflection, where the scenes are obtained by dividing the virtual scene according to the target reflection capture object.

The scenes corresponding to the effect-taking direction of the specular reflection may be scenes corresponding to a region to which the cube map of the target reflection capture object can be projected in the virtual scene.

In some aspects, if a virtual object is located in a field of view and in some scenes corresponding to an effect-taking direction of specular reflection, the terminal device determines the virtual object as a target virtual object. If a virtual object is located in a field of view and not in some scenes corresponding to an effect-taking direction of specular reflection, the terminal device cannot determine the virtual object as a target virtual object. If a virtual object is not located in a field of view and in some scenes corresponding to an effect-taking direction of specular reflection, the terminal device cannot determine the virtual object as a target virtual object. If a virtual object is not located in a field of view and not in some scenes corresponding to an effect-taking direction of specular reflection, the terminal device cannot determine the virtual object as a target virtual object. In this way, in a case that the target reflection capture object is a specular reflection object, the target virtual object may be simply and quickly determined according to the field of view and some scenes corresponding to the effect-taking direction of specular reflection, thereby effectively improving efficiency of determining the target virtual object.

The process of re-rendering a target virtual object is described below by using several aspects.

In some aspects, that the terminal device re-renders the target virtual object to generate a re-rendered target virtual object includes: generating, for any target virtual object, a rendering instruction of the target virtual object; and transmitting a rendering instruction of the target virtual object to an image processor, where the rendering instruction is configured for triggering the image processor to re-render a surface material of the target virtual object to generate the re-rendered target virtual object.

In some aspects, the terminal device records the determined target virtual object in a state update list, and removes old data recorded in the state update list. In some aspects, the state update list includes an object identifier of the target virtual object. For example, the object identifier is configured for uniquely identifying a virtual object. The object identifier may be a name, a number, an icon, or the like of the virtual object. This is not limited as described herein. Subsequently, the terminal device generates a rendering instruction corresponding to each target virtual object in the state update list, and re-renders the target virtual objects by using the graphics processing unit in the terminal device according to the rendering instruction, to obtain re-rendered target virtual objects.

In some aspects, that the terminal device generates a rendering instruction corresponding to the target virtual object includes: setting a rendering state of the target virtual object according to attribute information of the target virtual object, and generating a rendering instruction corresponding to the rendering state.

In some aspects, the attribute information of the target virtual object is configured for representing a display attribute of the target virtual object. For example, the attribute information of the target virtual object includes a surface material of the target virtual object, vertex information of the target virtual object, and the like. The rendering state is a state to which rendering needs to be performed. Because a rendering instruction generation process includes a large number of computing operations, described herein, the target virtual object is selected from virtual objects included in the field of view, and only the rendering instruction of the target virtual object is updated, so that the number of rendering instructions needing to be updated is reduced, computing overheads in a virtual object rendering process can be effectively reduced, rendering performance of a computer can be improved, and a target application can provide a high-quality display picture.

The following describes the process of generating a rendering instruction of a target virtual object by using an example.

The terminal device marks a target virtual object to obtain an object identifier of the target virtual object. The terminal device sets all marked virtual objects as target virtual objects in a process of generating a rendering instruction. The object identifier of the target virtual object is recorded in a dynamic update list (PrimitivesNeedingStaticMeshUpdate) of the virtual scene.

The terminal device traverses the dynamic update list (PrimitivesNeedingStaticMeshUpdate) by calling a visibility computing function (Compute View Visibility), and removes old data from the dynamic update list, to update attribute information of the target virtual object.

For each target virtual object, the terminal device re-generates a rendering instruction for the target virtual object based on the attribute information of the target virtual object.

The terminal device generates a display picture of the field of view through rendering by using the graphics processing unit according to the rendering instruction of each virtual object.

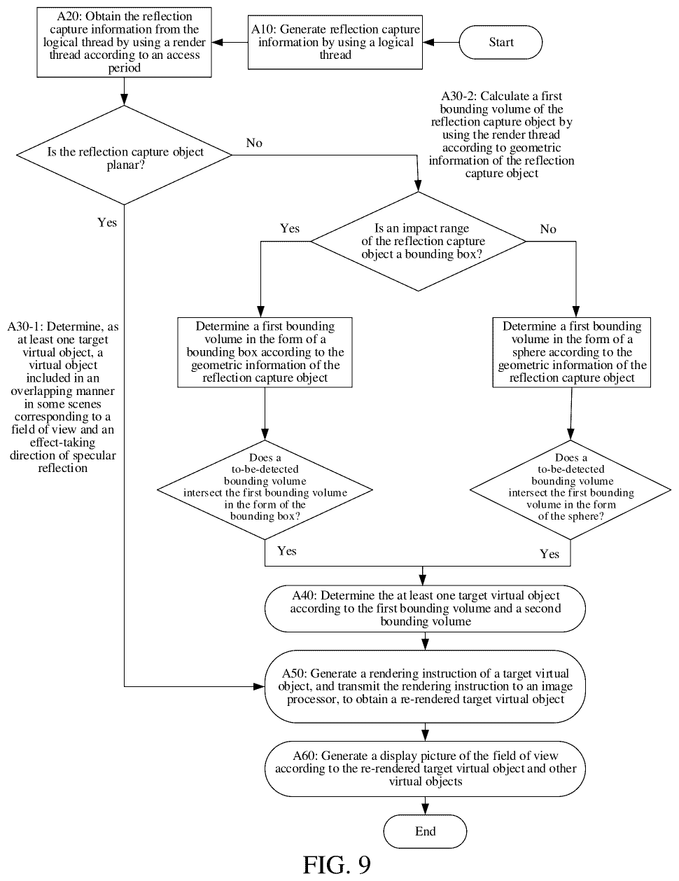

The following describes a picture rendering method by using an example with reference to FIG. 9. The method is mainly participated by a logical thread and a render thread in a terminal device. The method mainly includes the following several operations.

Operation A10: Generate reflection capture information by using a logical thread in a case that a reflection effect of a reflection capture object is changed, where the logical thread is configured for managing a logical operation related to a virtual scene.

In some aspects, the reflection capture information includes at least one reflection capture object having the reflection effect changed.

Operation A20: Obtain the reflection capture information from the logical thread by using a render thread according to an access period.

Operation A30-1: Determine, as at least one target virtual object, a virtual object included in an overlapping manner in some scenes corresponding to a field of view and an effect-taking direction of specular reflection in a case that the reflection capture object is a specular reflection object. After this operation is performed, operation A50 is directly performed.

Operation A30-2: Calculate a first bounding volume of the reflection capture object by using the render thread according to geometric information of the reflection capture object.

Operation A40: Determine, by using the render thread, the at least one target virtual object according to the first bounding volume and a second bounding volume corresponding to the at least one virtual object.

Operation A40 mainly includes the following several cases.

1. The first bounding volume is a cuboid bounding box. A first normal vector group of the first bounding volume is calculated by using the render thread based on vertex information of the first bounding volume. A second normal vector group of a to-be-detected bounding volume is determined according to vertex information of the to-be-detected bounding volume. A cross product vector between two normal vectors respectively from the first normal vector group and the second normal vector group is calculated, where the cross product vector is a result vector obtained by vector cross multiplication. The first normal vector, the second normal vector, and the cross product vector are set as k separation axes between the first bounding volume and the to-be-detected bounding volume. An intersection situation between the first bounding volume and the to-be-detected bounding volume is determined according to projections of the first bounding volume and the to-be-detected bounding volume on the k separation axes.

2. The first bounding volume is a sphere. A base vector group of the to-be-detected bounding volume is determined by using the render thread according to vertex information of the to-be-detected bounding volume, where the base vector group includes a base vector for representing a side length direction of the to-be-detected bounding volume. The center point is projected onto the base vector according to coordinate information of a center point of the first bounding volume, and coordinate information of a target position point nearest to the center point in the second bounding volume is calculated. An intersection situation between the first bounding volume and the to-be-detected bounding volume is determined according to the coordinate information of the center point, the coordinate information of the target position point, and a radius of the first bounding volume.

Operation A50: Generate, for any target virtual object, a rendering instruction of the target virtual object. A rendering instruction of the target virtual object is transmitted to an image processor, where the rendering instruction is configured for triggering the image processor to re-render a surface material of the target virtual object to generate the re-rendered target virtual object.

Operation A60: Generate a display picture of the field of view according to the re-rendered target virtual object and virtual objects other than the target virtual object in the field of view.

By using this method, the number of drawing instructions needing to be updated is reduced, thereby improving rendering performance of the terminal device and avoiding picture frame freezing. For content that is not described in this aspect described herein, refer to the foregoing aspect. Details are not described herein again.

The following describes a picture rendering method by using another example. The method is mainly performed by a logical thread and a render thread in a terminal device. The render thread includes a plurality of sub-threads. The method mainly includes the following several operations (not shown in the figure).

Operation B10: Establish m sub-threads according to a number n of central processing units of a terminal device, where n is a positive integer, and m is less than or equal to n.

Operation B20: Create a thread pool, where the thread pool includes the foregoing m sub-threads, the thread pool is configured for managing thread periods of the m sub-threads, and the sub-threads are canceled after tasks of the sub-threads are ended, to avoid large performance consumption of the sub-threads.

Operation B30: Divide a plurality of virtual objects in a field of view, to obtain m virtual object subsets. For example, if there are 10000 virtual objects in the field of view and the thread pool includes eight sub-threads, each virtual object subset includes 1250 virtual objects. In some aspects, the plurality of virtual objects in the field of view may further be dynamically divided. For details, refer to the foregoing aspect.

Operation B40: Generate reflection capture information by using a logical thread in a case that a reflection effect of a reflection capture object is changed, where the logical thread is configured for managing a logical operation related to a virtual scene.

Operation B50: Obtain the reflection capture information from the logical thread by using each sub-thread according to an access period.

Operation B60: Verify, by using each sub-thread according to a type of the reflection capture object recorded in the reflection capture information, whether a virtual object in the virtual object subset is a target virtual object, to obtain an object queue of each sub-thread. For details of the operation, refer to the foregoing aspects. Details are not described herein again.

Operation B70: Combine, after the plurality of sub-threads respectively determine object queues, the object queues of the sub-threads, to obtain at least one target virtual object.

Operation B80: Generate, for any target virtual object, a rendering instruction of the target virtual object. The rendering instruction of the target virtual object is transmitted to an image processor, where the rendering instruction is configured for triggering the image processor to re-render a surface material of the target virtual object to generate the re-rendered target virtual object.

Operation B90: Generate a display picture of the field of view according to the re-rendered target virtual object and virtual objects other than the target virtual object in the field of view.

The process of selecting a target object is performed concurrently by using a plurality of sub-threads, so that computing resources in the terminal device can be fully used, thereby increasing a speed of verifying the target virtual object, and shortening time consumed by introducing the method.

An application scenario of a picture rendering method provided described herein includes at least one of the following: generation of a game picture in a game battle, a process of generating a virtual picture in a mixed reality application, generation of a three-dimensional navigation animation in a navigation program, capture of a virtual character motion picture in an animation production process, and the like. For example, in the process of generating a game picture, a virtual scene is a virtual environment in a game battle, a virtual object is a three-dimensional model in the virtual environment, and a display picture is a game picture displayed by a terminal device. For another example, in a mixed reality application, the virtual scene is a three-dimensional model that needs to be fused with a reality scene, and the display picture is configured for displaying an upper layer of an environment picture shot by a camera in the real world. In some aspects, the game picture may be generated by a game engine corresponding to a game application, such as an unreal engine (UE).

The foregoing application scenarios are merely configured for listing uses of the picture rendering method, and the application scenarios of the picture rendering method provided described herein are not limited.

In some aspects, the picture rendering method provided described herein is performed by a server, such as a background server of the target application. For example, the display picture in this aspect described herein is generated by the server and displayed by a client. For example, when there is a target reflection capture object having a reflection effect changed, the server generates a target virtual object to be re-rendered and generates a display picture of a field of view. The server transmits the display picture to the client, and then the client displays the display picture, thereby reducing computing pressure of the terminal device.

In some aspects, this aspect described herein may greatly reduce picture frame freezing caused by update of a reflection capture object in a complex virtual scene. An open world game is used as an example. In a large world scenario including approximately 11000 virtual objects, a process of controlling a virtual character to run in a map triggers update of a reflection capture object. Before the technical solution provided in this aspect described herein is used, for a field of view, update of the reflection capture object may cause more than approximately 1000 virtual objects to be updated. However, after the technical solution provided in this aspect described herein is used, the number of updated virtual objects becomes approximately 20. In this way, a frame freezing time of more than 60 milliseconds (ms) of the terminal device is improved to be less than 33.3 ms, satisfying a standard of 30 frames per second (FPS).

The following describes apparatus aspects described herein, which may be configured for executing the method aspects described herein. For details not disclosed in the apparatus aspects described herein, refer to the method aspects described herein.

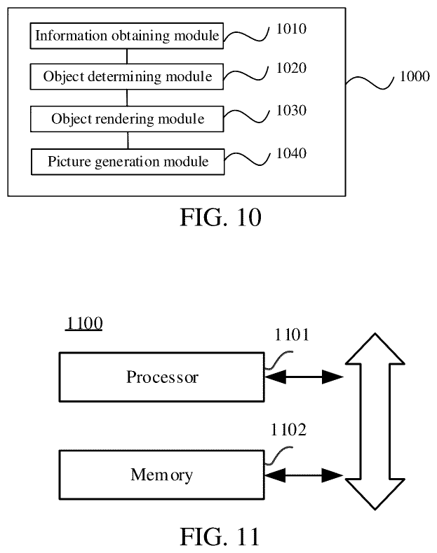

FIG. 10 shows a block diagram of a picture rendering apparatus according to an illustrative aspect described herein. The apparatus may be implemented as all or a part of a terminal device by software, hardware, or a combination of software and hardware. The apparatus 1000 may include: an information obtaining module 1010, an object determining module 1020, an object rendering module 1030, and a picture generation module 1040.

The information obtaining module 1010 is configured to obtain reflection capture information of a virtual scene, where the reflection capture information includes geometric information of at least one reflection capture object, and the reflection capture object is configured for projecting a cube map representing a reflection effect onto a material surface of a virtual object.

The object determining module 1020 is configured to determine, in the presence of a target reflection capture object having the reflection effect changed in the at least one reflection capture object, at least one target virtual object from at least one virtual object included in a field of view according to the geometric information of the target reflection capture object, where the target virtual object is a virtual object having a surface display effect changed when the reflection effect of the target reflection capture object is changed.

The object rendering module 1030 is configured to re-render the target virtual object to generate a re-rendered target virtual object, a texture of the material surface of the re-rendered target virtual object being changed.

The picture generation module 1040 is configured to generate a display picture of the field of view according to the re-rendered target virtual object and virtual objects other than the target virtual object in the at least one virtual object.

In some aspects, the object determining module 1020 includes: a bounding volume determining unit, configured to calculate a first bounding volume of the target reflection capture object according to the geometric information of the target reflection capture object, where the first bounding volume is a geometric space in which the target reflection capture object takes effect in the virtual scene; and an object determining unit, configured to determine the at least one target virtual object according to the first bounding volume and a second bounding volume corresponding to the at least one virtual object, where the second bounding volume is a geometric space occupied by the virtual object in the virtual scene.

In some aspects, the object determining unit is configured to determine, for any to-be-detected bounding volume in the second bounding volume corresponding to the at least one virtual object, a virtual object corresponding to the to-be-detected bounding volume as the target virtual object if the to-be-detected bounding volume intersects with the first bounding volume.

In some aspects, the operation of determining at least one target virtual object is performed by a render thread. The render thread includes a plurality of sub-threads. The object determining unit is configured to: calculate, for any sub-thread among the plurality of sub-threads, a second bounding volume corresponding to each virtual object in a virtual object subset by using the sub-thread, where the virtual object subset includes m virtual objects in the at least one virtual object, each sub-thread corresponds to one virtual object subset, and m is a positive integer; add, for a to-be-detected bounding volume corresponding to a to-be-detected virtual object in the virtual object subset, a virtual object corresponding to the to-be-detected bounding volume to an object queue if the to-be-detected bounding volume intersects with the first bounding volume, where the object queue includes a target virtual object in the virtual object subset; and combine, after the plurality of sub-threads respectively determine object queues, the object queues of the sub-threads, to obtain the at least one target virtual object.

In some aspects, the apparatus 1000 further includes: a first determining module, configured to: calculate a first normal vector group of the first bounding volume according to vertex information of the first bounding volume in a case that the first bounding volume is a cuboid and the to-be-detected bounding volume is a cuboid, where the first normal vector group includes a first normal vector perpendicular to a plane of the first bounding volume; determine a second normal vector group of the to-be-detected bounding volume according to vertex information of the to-be-detected bounding volume, where the second normal vector group includes a second normal vector perpendicular to a plane of the to-be-detected bounding volume; calculate a cross product vector between two normal vectors respectively from the first normal vector group and the second normal vector group, where the cross product vector is a result vector obtained by vector cross multiplication; set the first normal vector, the second normal vector, and the cross product vector as k separation axes between the first bounding volume and the to-be-detected bounding volume, where k is a positive integer; and determine an intersection situation between the first bounding volume and the to-be-detected bounding volume according to projections of the first bounding volume and the to-be-detected bounding volume on the k separation axes, where the intersection situation is configured for indicating whether the first bounding volume intersects with the to-be-detected bounding volume.

In some aspects, the apparatus 1000 further includes: a second determining module, configured to: determine a base vector group of the to-be-detected bounding volume according to vertex information of the to-be-detected bounding volume in a case that the first bounding volume is a sphere and the to-be-detected bounding volume is a cuboid, where the base vector group includes a base vector for representing a side length direction of the to-be-detected bounding volume; project, according to coordinate information of a center point of the first bounding volume, the center point onto the base vector, and calculate coordinate information of a target position point nearest to the center point in the second bounding volume; and determine an intersection situation between the first bounding volume and the to-be-detected bounding volume according to the coordinate information of the center point, the coordinate information of the target position point, and a radius of the first bounding volume, where the intersection situation is configured for indicating whether the first bounding volume intersects with the to-be-detected bounding volume.

In some aspects, the target reflection capture object is a specular reflection object. The geometric information of the target reflection capture object includes an effect-taking direction for performing specular reflection. The effect-taking direction is a projection direction of the cube map. The object determining module 1020 is configured to determine, as the at least one target virtual object, a virtual object included in an overlapping manner in some scenes corresponding to the field of view and the effect-taking direction of the specular reflection, where the scenes are obtained by dividing the virtual scene according to the target reflection capture object.

In some aspects, the information obtaining module 1010 is configured to: generate the reflection capture information by using a logical thread, where the logical thread is configured for managing a logical operation related to the virtual scene; and obtain the reflection capture information from the logical thread by using a render thread according to an access period, where the render thread is configured for generating the display picture of the field of view through rendering.

In some aspects, the object rendering module 1030 is configured to: generate, for any target virtual object, a rendering instruction of the target virtual object; and transmit a rendering instruction of the target virtual object to an image processor, where the rendering instruction is configured for triggering the image processor to re-render a surface material of the target virtual object to generate the re-rendered target virtual object.

In conclusion, in a case that a reflection effect of a reflection capture object is changed, a virtual object affected by the reflection capture object is selected from virtual objects included in a field of view, and only a rendering instruction of the selected virtual object is updated, so that the number of updated rendering instructions can be effectively reduced. In this manner, the problem of a computing pressure rise caused by updating the rendering instruction when the reflection effect of the reflection capture object is changed is reduced, thereby reducing power consumption of a terminal device.

In addition, by reducing the number of virtual objects needing to be updated and rendered, a computing pressure in a process of generating a display picture by the terminal device when the reflection effect of the reflection capture object is changed is reduced, thereby reducing a probability that a picture frame freezing problem occurs. Therefore, a frame rate at which the display picture is updated keeps stable, thereby improving rendering performance of the terminal device, and maintaining smoothness of the display picture in a use process of a target application.

When the apparatus provided in the foregoing aspect implements the functions of the apparatus, only division of the foregoing functional modules is described by using examples. In a practical application, the functions may be completed by different functional modules as required. To be specific, a content structure of a device is divided into different functional modules to complete all or part of the functions described above. In addition, the apparatus provided in the foregoing aspect belongs to the same idea as the method aspect. For a specific implementation process thereof, refer to the method aspect. Details are not described herein again. For beneficial effects of the apparatus in the foregoing aspects, refer to descriptions of the method aspect. Details are not described herein again.

FIG. 11 shows a structural block diagram of a terminal device according to an illustrative aspect described herein. The terminal device 1100 may be the terminal device described above.

Generally, the terminal device 1100 includes: a processor 1101 and a memory 1102.

The processor 1101 may include one or more processing cores, for example, a 4-core processor or an 11-core processor. The processor 1101 may be implemented in at least one hardware form of a digital signal processor (DSP), a field programmable gate array (FPGA), and a programmable logic array (PLA). The processor 1101 further includes a main processor and a coprocessor. The main processor is configured to process data in an active state, also referred to as a central processing unit (CPU). The coprocessor is a low-power processor configured to process the data in a standby state. In some aspects, the processor 1101 may be integrated with a graphics processing unit (GPU). The GPU is configured to render and draw content that needs to be displayed on a display screen. In some aspects, the processor 1101 may further include an artificial intelligence (AI) processor. The AI processor is configured to process computing operations related to machine learning.

The memory 1102 may include one or more computer-readable storage mediums. The computer-readable storage medium may be visible and non-transient. The memory 1102 may further include a high-speed random access memory and a nonvolatile memory, for example, one or more disk storage devices or flash storage devices. In some aspects, the non-transient computer-readable storage medium in the memory 1102 stores at least one instruction, at least one program, a code set, or an instruction set. The at least one instruction, the at least one program, the code set, or the instruction set is executed by the processor 1101 to implement the foregoing picture rendering method.

A person skilled in the art may understand that the structure shown in FIG. 11 constitutes no limitation on the terminal device 1100, and the terminal device may include more or fewer components than those shown in the figure, or some components may be combined, or a different component arrangement may be used.

An aspect described herein further provides a computer-readable storage medium. The storage medium has a computer program stored therein. The computer program is loaded and executed by a processor to implement the foregoing picture rendering method.

The computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a random access memory (RAM), a read-only memory (ROM), an erasable programmable read-only memory (EPROM), an electrically erasable programmable read-only memory (EEPROM), a flash memory or another solid-state memory technology, a digital video disc (DVD) or another optical memory, a tape cartridge, a magnetic cassette, a magnetic disk memory, or another magnetic storage device. Certainly, a person skilled in art may know that the computer storage medium is not limited to the foregoing several types.

An aspect described herein further provides a computer program product. The computer program product includes a computer program. The computer program is stored in a computer-readable storage medium. A processor reads and executes the computer program from the computer-readable storage medium, to implement the foregoing picture rendering method.

In this aspect described herein, a prompt interface and a pop-up window may be displayed or voice prompt information is outputted before relevant data of a user is collected and during collection of relevant data of the user. The prompt interface, the pop-up window, or the voice prompt information is configured for prompting that relevant data of the user is being collected currently, so that aspects described herein start the relevant operations of obtaining user-related data only after obtaining a confirm operation performed by the user on the prompt interface or the pop-up window, or otherwise (i.e., when the confirm operation performed by the user on the prompt interface or the pop-up window is not obtained), the relevant operations of obtaining user-related data are ended, i.e., the user-related data is not obtained. In other words, all user data collected by aspects described herein are processed in accordance with the requirements of relevant national laws and regulations. The informed consent or separate consent of a personal information subject is collected with the consent and authorization of the user, subsequent data use and processing activities are carried out within the scope of laws, regulations and the authorization of the personal information subject, and the collection, use and processing of user-related data need to comply with relevant laws, regulations and standards of relevant countries and regions. For example, a virtual scene, a virtual object, a display picture, and the like involved described herein are all obtained under full authorization.

“Plurality of” mentioned in the specification means two or more. The term “and/or” describes an association relationship between associated objects and indicates that three relationships may exist. For example, A and/or B may indicate the following three cases: A alone, both A and B, and B alone. The character “/” in this specification generally indicates an “or” relationship between the associated objects.

The foregoing descriptions are merely illustrative aspects described herein, but are not intended to limit the aspects described herein. Any modification, equivalent switching, or improvement made within the spirit and principle described herein falls within the protection scope described herein.

What is claimed is:

1. A computer-implemented method, comprising:
obtaining reflection capture information of a virtual scene, the reflection capture information comprising geometric information of at least one reflection capture object, and the reflection capture object being configured for projecting a cube map representing a reflection effect onto a material surface of a virtual object;
determining, in the presence of a target reflection capture object having the reflection effect changed in the at least one reflection capture object, at least one target virtual object from at least one virtual object comprised in a field of view according to the geometric information of the target reflection capture object, the target virtual object being a virtual object having a surface display effect changed when the reflection effect of the target reflection capture object is changed;
re-rendering the target virtual object to generate a re-rendered target virtual object, a texture of the material surface of the re-rendered target virtual object being changed; and
generating a display picture of the field of view according to the re-rendered target virtual object and virtual objects other than the target virtual object in the at least one virtual object.

2. The method according to claim 1, wherein the determining comprises:
calculating a first bounding volume of the target reflection capture object according to the geometric information of the target reflection capture object, the first bounding volume being a geometric space in which the target reflection capture object takes effect in the virtual scene; and
determining the at least one target virtual object according to the first bounding volume and a second bounding volume corresponding to the at least one virtual object, the second bounding volume being a geometric space occupied by the virtual object in the virtual scene.

3. The method according to claim 1, wherein the determining the at least one target virtual object according to the first bounding volume and the second bounding volume corresponding to the at least one virtual object comprises:
determining, for any to-be-detected bounding volume in the second bounding volume corresponding to the at least one virtual object, a virtual object corresponding to the to-be-detected bounding volume as the target virtual object when the to-be-detected bounding volume intersects with the first bounding volume.

4. The method according to claim 1, wherein determining at least one target virtual object is performed by a render thread, the render thread comprising a plurality of sub-threads; and
the determining the at least one target virtual object according to the first bounding volume and the second bounding volume corresponding to the at least one virtual object comprises:
calculating, for any sub-thread among the plurality of sub-threads, a second bounding volume corresponding to each virtual object in a virtual object subset by using the sub-thread, the virtual object subset one or more virtual objects in the at least one virtual object, each sub-thread corresponding to one virtual object subset;
adding, for a to-be-detected bounding volume corresponding to a to-be-detected virtual object in the virtual object subset, a virtual object corresponding to the to-be-detected bounding volume to an object queue when the to-be-detected bounding volume intersects with the first bounding volume, the object queue comprising a target virtual object in the virtual object subset; and
combining, after the plurality of sub-threads respectively determine object queues, the object queues of the sub-threads, to obtain the at least one target virtual object.

5. The method of claim 3, wherein before the determining the at least one target virtual object according to the first bounding volume and the second bounding volume corresponding to the at least one virtual object, the method further comprises:
calculating a first normal vector group of the first bounding volume according to vertex information of the first bounding volume when the first bounding volume is a cuboid and the to-be-detected bounding volume is a cuboid, wherein the first normal vector group comprises a first normal vector perpendicular to a plane of the first bounding volume;
determining a second normal vector group of the to-be-detected bounding volume according to vertex information of the to-be-detected bounding volume, wherein the second normal vector group comprises a second normal vector perpendicular to a plane of the to-be-detected bounding volume;
calculating a cross product vector between two normal vectors respectively from the first normal vector group and the second normal vector group, the cross product vector being a result vector obtained by vector cross multiplication;
setting the first normal vector, the second normal vector, and the cross product vector as one or more separation axes between the first bounding volume and the to-be-detected bounding volume; and
determining an intersection situation between the first bounding volume and the to-be-detected bounding volume according to projections of the first bounding volume and the to-be-detected bounding volume on the one or more separation axes, the intersection situation being configured for indicating whether the first bounding volume intersects with the to-be-detected bounding volume.

6. The method of claim 3, wherein before the determining the at least one target virtual object according to the first bounding volume and the second bounding volume corresponding to the at least one virtual object, the method further comprises:
determining a base vector group of the to-be-detected bounding volume according to vertex information of the to-be-detected bounding volume when the first bounding volume is a sphere and the to-be-detected bounding volume is a cuboid, wherein the base vector group comprises a base vector for representing a side length direction of the to-be-detected bounding volume;
projecting, according to coordinate information of a center point of the first bounding volume, the center point onto the base vector, and calculating coordinate information of a target position point nearest to the center point in the second bounding volume; and
determining an intersection situation between the first bounding volume and the to-be-detected bounding volume according to the coordinate information of the center point, the coordinate information of the target position point, and a radius of the first bounding volume, the intersection situation being configured for indicating whether the first bounding volume intersects with the to-be-detected bounding volume.

7. The method of claim 1, wherein the target reflection capture object is a specular reflection object, the geometric information of the target reflection capture object comprises an effect-taking direction for performing specular reflection, and the effect-taking direction is a projection direction of the cube map; and
the determining comprises:
determining, as the at least one target virtual object, a virtual object comprised in an overlapping manner in one or more scenes corresponding to the field of view and the effect-taking direction of the specular reflection, wherein the scenes are obtained by dividing the virtual scene according to the target reflection capture object.

8. The method of claim 1, wherein the obtaining reflection capture information of a virtual scene comprises:
generating the reflection capture information using a logical thread, the logical thread being configured for managing a logical operation related to the virtual scene; and
obtaining the reflection capture information from the logical thread using a render thread according to an access period, the render thread being configured for generating the display picture of the field of view through rendering.

9. The method of claim 1, wherein the re-rendering the target virtual object to generate a re-rendered target virtual object comprises:
generating, for any target virtual object, a rendering instruction of the target virtual object; and
transmitting a rendering instruction of the target virtual object to an image processor, the rendering instruction being configured for triggering the image processor to re-render a surface material of the target virtual object to generate the re-rendered target virtual object.

10. One or more non-transitory computer readable media comprising computer readable instructions that, when executed by a processor, configure a data processing system to perform:
obtaining reflection capture information of a virtual scene, the reflection capture information comprising geometric information of at least one reflection capture object, and the reflection capture object being configured for projecting a cube map representing a reflection effect onto a material surface of a virtual object;
determining, in the presence of a target reflection capture object having the reflection effect changed in the at least one reflection capture object, at least one target virtual object from at least one virtual object comprised in a field of view according to the geometric information of the target reflection capture object, the target virtual object being a virtual object having a surface display effect changed when the reflection effect of the target reflection capture object is changed;
re-rendering the target virtual object to generate a re-rendered target virtual object, a texture of the material surface of the re-rendered target virtual object being changed; and
generating a display picture of the field of view according to the re-rendered target virtual object and virtual objects other than the target virtual object in the at least one virtual object.

11. The computer readable media according to claim 10, wherein the determining comprises:
calculating a first bounding volume of the target reflection capture object according to the geometric information of the target reflection capture object, the first bounding volume being a geometric space in which the target reflection capture object takes effect in the virtual scene; and
determining the at least one target virtual object according to the first bounding volume and a second bounding volume corresponding to the at least one virtual object, the second bounding volume being a geometric space occupied by the virtual object in the virtual scene.

12. The computer readable media according to claim 10, wherein the determining the at least one target virtual object according to the first bounding volume and the second bounding volume corresponding to the at least one virtual object comprises:
determining, for any to-be-detected bounding volume in the second bounding volume corresponding to the at least one virtual object, a virtual object corresponding to the to-be-detected bounding volume as the target virtual object when the to-be-detected bounding volume intersects with the first bounding volume.

13. The computer readable media according to claim 10, wherein determining at least one target virtual object is performed by a render thread, the render thread comprising a plurality of sub-threads; and
the determining the at least one target virtual object according to the first bounding volume and the second bounding volume corresponding to the at least one virtual object comprises:
calculating, for any sub-thread among the plurality of sub-threads, a second bounding volume corresponding to each virtual object in a virtual object subset by using the sub-thread, the virtual object subset one or more virtual objects in the at least one virtual object, each sub-thread corresponding to one virtual object subset;
adding, for a to-be-detected bounding volume corresponding to a to-be-detected virtual object in the virtual object subset, a virtual object corresponding to the to-be-detected bounding volume to an object queue when the to-be-detected bounding volume intersects with the first bounding volume, the object queue comprising a target virtual object in the virtual object subset; and
combining, after the plurality of sub-threads respectively determine object queues, the object queues of the sub-threads, to obtain the at least one target virtual object.

14. The computer readable media of claim 12, wherein before the determining the at least one target virtual object according to the first bounding volume and the second bounding volume corresponding to the at least one virtual object, the system performs:
calculating a first normal vector group of the first bounding volume according to vertex information of the first bounding volume when the first bounding volume is a cuboid and the to-be-detected bounding volume is a cuboid, wherein the first normal vector group comprises a first normal vector perpendicular to a plane of the first bounding volume;
determining a second normal vector group of the to-be-detected bounding volume according to vertex information of the to-be-detected bounding volume, wherein the second normal vector group comprises a second normal vector perpendicular to a plane of the to-be-detected bounding volume;
calculating a cross product vector between two normal vectors respectively from the first normal vector group and the second normal vector group, the cross product vector being a result vector obtained by vector cross multiplication;
setting the first normal vector, the second normal vector, and the cross product vector as one or more separation axes between the first bounding volume and the to-be-detected bounding volume; and
determining an intersection situation between the first bounding volume and the to-be-detected bounding volume according to projections of the first bounding volume and the to-be-detected bounding volume on the one or more separation axes, the intersection situation being configured for indicating whether the first bounding volume intersects with the to-be-detected bounding volume.

15. The computer readable media of claim 12, wherein before the determining the at least one target virtual object according to the first bounding volume and the second bounding volume corresponding to the at least one virtual object, the system performs:
determining a base vector group of the to-be-detected bounding volume according to vertex information of the to-be-detected bounding volume when the first bounding volume is a sphere and the to-be-detected bounding volume is a cuboid, wherein the base vector group comprises a base vector for representing a side length direction of the to-be-detected bounding volume;
projecting, according to coordinate information of a center point of the first bounding volume, the center point onto the base vector, and calculating coordinate information of a target position point nearest to the center point in the second bounding volume; and
determining an intersection situation between the first bounding volume and the to-be-detected bounding volume according to the coordinate information of the center point, the coordinate information of the target position point, and a radius of the first bounding volume, the intersection situation being configured for indicating whether the first bounding volume intersects with the to-be-detected bounding volume.

16. The computer readable media of claim 10, wherein the target reflection capture object is a specular reflection object, the geometric information of the target reflection capture object comprises an effect-taking direction for performing specular reflection, and the effect-taking direction is a projection direction of the cube map; and
the determining comprises:
determining, as the at least one target virtual object, a virtual object comprised in an overlapping manner in one or more scenes corresponding to the field of view and the effect-taking direction of the specular reflection, wherein the scenes are obtained by dividing the virtual scene according to the target reflection capture object.

17. The computer readable media of claim 10, wherein the obtaining reflection capture information of a virtual scene comprises:
generating the reflection capture information using a logical thread, the logical thread being configured for managing a logical operation related to the virtual scene; and
obtaining the reflection capture information from the logical thread using a render thread according to an access period, the render thread being configured for generating the display picture of the field of view through rendering.

18. The computer readable media of claim 10, wherein the re-rendering the target virtual object to generate a re-rendered target virtual object comprises:
generating, for any target virtual object, a rendering instruction of the target virtual object; and
transmitting a rendering instruction of the target virtual object to an image processor, the rendering instruction being configured for triggering the image processor to re-render a surface material of the target virtual object to generate the re-rendered target virtual object.

19. A system comprising: a processor, and memory storing computer readable instructions that, when executed by the processor, configure the system to perform:
obtaining reflection capture information of a virtual scene, the reflection capture information comprising geometric information of at least one reflection capture object, and the reflection capture object being configured for projecting a cube map representing a reflection effect onto a material surface of a virtual object;
determining, in the presence of a target reflection capture object having the reflection effect changed in the at least one reflection capture object, at least one target virtual object from at least one virtual object comprised in a field of view according to the geometric information of the target reflection capture object, the target virtual object being a virtual object having a surface display effect changed when the reflection effect of the target reflection capture object is changed;
re-rendering the target virtual object to generate a re-rendered target virtual object, a texture of the material surface of the re-rendered target virtual object being changed; and
generating a display picture of the field of view according to the re-rendered target virtual object and virtual objects other than the target virtual object in the at least one virtual object.

20. The system according to claim 19, wherein the determining comprises:
calculating a first bounding volume of the target reflection capture object according to the geometric information of the target reflection capture object, the first bounding volume being a geometric space in which the target reflection capture object takes effect in the virtual scene; and
determining the at least one target virtual object according to the first bounding volume and a second bounding volume corresponding to the at least one virtual object, the second bounding volume being a geometric space occupied by the virtual object in the virtual scene.
